(19) United States
(12) Patent Application Publication
(10) Pub. No.: US 2024/0357518 A1
(43) Pub. Date: Oct. 24, 2024

(54) ELECTRONIC DEVICE AND OPERATION METHOD FOR CHANGING RADIO FREQUENCY PATH ON BASIS OF ELECTROMAGNETIC WAVE ABSORPTION RATE

(71) Applicant: SAMSUNG ELECTRONICS CO., LTD., Suwon-si (KR)

(72) Inventors: Jaemoon CHA, Suwon-si (KR); Kyunghoon MOON, Suwon-si (KR); Jungsuk WOO, Suwon-si, Gyeonggi-do (KR); Jaegon GHIM, Suwon-si, Gyeonggi-do (KR)

(21) Appl. No.: 18/763,487

(22) Filed: Jul. 3, 2024

Related U.S. Application Data
(63) Continuation of application No. PCT/KR2022/016920, filed on Nov. 1, 2022.

(30) Foreign Application Priority Data
Jan. 6, 2022 (KR) 10-2022-0002299
Mar. 10, 2022 (KR) 10-2022-0029946

(51) Int. Cl. H04W 52/36; H04W 52/16; H04W 52/38

(52) U.S. Cl. CPC H04W 52/367; H04W 52/16; H04W 52/38

(57) ABSTRACT

According to various embodiments, an electronic device configures a first maximum transmission power limit for a first RF path, transmits, through the first RF path, a first RF signal using transmission power configured based on the first maximum transmission power limit, configures a second maximum transmission power limit for a second RF path, transmits, through the second RF path, a second RF signal using transmission power configured based on the second maximum transmission power limit; identifies whether an RF path change condition is satisfied, transmits, through a third RF path, the second RF signal using transmission power configured based on a third maximum transmission power limit and transmits, through the first RF path, the first RF signal using the transmission power configured based on the first maximum transmission power limit. Various other embodiments are possible.

### CROSS-REFERENCE TO RELATED APPLICATION (S)

This application is a continuation application, claiming priority under § 365 (c), of International Application No. PCT/KR2022/016920 filed on Nov. 1, 2022, which is based on and claims the benefit of Korean patent application number 10-2022-0029946 filed on Mar. 10, 2022, in the Korean Intellectual Property Office and of Korean patent application number 10-2022-0002299 filed on Jan. 6, 2022, in the Korean Intellectual Property Office, the disclosures of which are incorporated by reference herein in their entireties.

### TECHNICAL FIELD

Various embodiments of the disclosure relate to an electronic device and operation method for changing a transmission radio frequency (RF) path based on a specific absorption rate (SAR).

### BACKGROUND ART

A piece of user equipment (UE) may transmit electromagnetic waves to transmit/receive data to/from a base station. Electromagnetic waves radiated from the UE may harm the human body, and various domestic or foreign organizations attempt to restrict the harmful electromagnetic waves. For example, the specific absorption rate (SAR) is a value indicating how much electromagnetic radiation from a mobile communication terminal is absorbed by the human body. SAR uses the unit of KW/g (or mW/g), which may mean the amount of power (KW, W or mW) absorbed per 1 g of the human body. As the issue of harmfulness of electromagnetic waves attracts attention, SAR limit standards for mobile communication terminals have been established.

The UE may back off the transmission power (or maximum transmission power limit (MTPL)), e.g., if the SAR expected by the transmission power is expected to exceed a threshold. For example, upon identifying that a specific event (e.g., a grip, hot-spot, or proximity) occurs, the UE may transmit an RF signal in the backoff power condition corresponding to the event or may transmit a communication signal in the transmission power set based on the backed-off MTPL.

Further, a notion of backing off the transmission power (or MTPL) based on the total SAR value accumulated for a predetermined time (or the average of the SARs generated for a predetermined time) has been proposed. The SAR that instantaneously affects the human body and/or the SAR that affects the human body on average should also be considered. Therefore, the transmission power (or MTPL) when the total SAR value accumulated (or the average of the SARs generated for a predetermined time) meets a designated condition may be backed off.

### DETAILED DESCRIPTION OF THE INVENTION

### Technical Problem

The UE may transmit two RF signals using the two RF paths, respectively, which may be referred to as 2 TX. For example, the UE may transmit the two RF signals based on multi radio access technology (RAT)-dual connectivity (MR-DC) at least simultaneously through the two RF paths, respectively. For example, the UE may transmit the two RF signals based on protocol stacks of a dual subscriber identification module (SIM) (DSDA) at least simultaneously through the two RF paths, respectively. In the case of 2 TX, when RF signals are transmitted through the physically adjacent antennas, because the sum of SARs by the respective RF signals is calculated as the total SAR, the accumulated SAR may increase relatively rapidly. In this case, due to the relatively rapid increase in the accumulated SAR, a backoff of one transmission power or MTPL of 2TX may be required. When the transmit power or the MTPL is backed off, the possibility that the communication connection is released may increase.

An electronic device and an operation method thereof according to various embodiments may change any one RF path of 2 TX when the accumulated SAR meets an RF path change condition during a 2 TX operation.

### Technical Solution

According to various embodiments, an electronic device may comprise a plurality of antennas, at least one RF (radio frequency) circuit, memory storing instructions, and at least one processor. The instructions may cause the electronic device to set a first maximum transmission power limit for a first RF path of the electronic device, the first RF path being associated with a first antenna among the plurality of antennas, control at least part of the at least one RF circuit associated with the first RF path to transmit a first RF signal with a transmission power set based on the first maximum transmission power limit, through the first RF path, set a second maximum transmission power limit for a second RF path of the electronic device, the second RF path being associated with a second antenna among the plurality of antennas, and a distance between the first antenna and the second antenna being less than a designated threshold distance, control at least part of the at least one RF circuit associated with the second RF path to transmit a second RF signal with a transmission power set based on the second maximum transmission power limit, through the second RF path, identify whether a first accumulated SAR corresponding to the first RF path and a second accumulated SAR (specific absorption rate) corresponding to the second RF path satisfy an RF path change condition, based on the first accumulated SAR and the second accumulated SAR satisfying the RF path change condition, control at least part of the at least one RF circuit associated with a third RF path to transmit the second RF signal with a transmission power set based on a third maximum transmission power limit, through the third RF path of the electronic device, the third RF path being associated with a third antenna among the plurality of antennas, and a distance between the first antenna and the third antenna being larger than or equal to a designated threshold distance, and control at least part of the at least one RF circuit associated with the first RF path to transmit the first RF signal with the transmission power set based on the first maximum transmission power limit, through the first RF path.

According to various embodiments, an operation method of an electronic device including a plurality of antennas and at least one RF circuit may comprise setting a first maximum transmission power limit for a first RF path of the electronic device, the first RF path being associated with a first antenna among the plurality of antennas, controlling at least part of the at least one RF circuit associated with the first RF path to transmit a first RF signal with a transmission power set based on the first maximum transmission power limit, through the first RF path, setting a second maximum transmission power limit for a second RF path of the electronic device, the second RF path being associated with a second antenna among the plurality of antennas, and a distance between the first antenna and the second antenna being less than a designated threshold distance, controlling at least part of the at least one RF circuit associated with the second RF path to transmit a second RF signal with a transmission power set based on the second maximum transmission power limit, through the second RF path, identifying whether a first accumulated SAR corresponding to the first RF path and a second accumulated SAR corresponding to the second RF path satisfy an RF path change condition, based on the first accumulated SAR and the second accumulated SAR satisfying the RF path change condition, controlling at least part of the at least one RF circuit associated with a third RF path to transmit the second RF signal with a transmission power set based on a third maximum transmission power limit, through the third RF path of the electronic device, the third RF path being associated with a third antenna among the plurality of antennas, and a distance between the first antenna and the third antenna being larger than or equal to a designated threshold distance, and controlling at least part of the at least one RF circuit associated with the first RF path to transmit the first RF signal with the transmission power set based on the first maximum transmission power limit, through the first RF path.

According to various embodiments, an electronic device may comprise a plurality of antennas, at least one RF circuit, memory storing instructions, and at least one processor. The instructions may cause the electronic device to set a first maximum transmission power limit for a first RF path of the electronic device, the first RF path being associated with a first antenna among the plurality of antennas, control at least part of the at least one RF circuit associated with the first RF path to transmit a first RF signal with a transmission power set based on the first maximum transmission power limit, through the first RF path, identify whether a first accumulated SAR corresponding to the first RF path satisfies a designated condition based on identifying that transmission of a second RF signal different from the first RF signal is required, set a second maximum transmission power limit for a second RF path of the electronic device based on the first accumulated SAR satisfying the designated condition, control at least part of the at least one RF circuit associated with the second RF path to transmit the second RF signal with a transmission power set based on the second maximum transmission power limit, the second RF path being associated with a second antenna among the plurality of antennas, and a distance between the first antenna and the second antenna being less than a designated threshold distance, set a third maximum transmission power limit for a third RF path of the electronic device based on the first accumulated SAR not satisfying the designated condition, control at least part of the at least one RF circuit associated with the third RF path to transmit the second RF signal with a transmission power set based on the third maximum transmission power limit, the third RF path being associated with a third antenna among the plurality of antennas, and a distance between the first antenna and the third antenna being the designated threshold distance or more.

### Advantageous Effects

According to various embodiments, there may be provided an electronic device and operation method thereof, capable of changing any one RF path of 2 TX when an accumulated SAR satisfies an RF path change condition during a 2 TX operation. The antenna of the changed RF path may be physically spaced apart from the antenna of the remaining RF path by a designated distance or more, and the SAR affecting the user may be set to the maximum value among the SARs, not the sum of the SARs based on both RF paths. Accordingly, the increase rate of the accumulated value of the SARs generated in the electronic device may be lower than before the change, and the backoff of the transmission power (or MTPL) in any RF path may be delayed or prevented.

### BRIEF DESCRIPTION OF DRAWINGS

FIG. 1 is a view illustrating an electronic device in a network environment according to various embodiments;

FIG. 2A is a block diagram illustrating an electronic device for supporting legacy network communication and 5G network communication according to various embodiments;

FIG. 2B is a block diagram illustrating an electronic device for supporting legacy network communication and 5G network communication according to various embodiments;

FIG. 3A is a flowchart illustrating an operation method of an electronic device according to various embodiments;

FIG. 3B is a view illustrating transmission power and SAR over time according to various embodiments;

FIGS. 4A, 4B, and 4C illustrate graphs of transmission power per time according to various embodiments;

FIGS. 4D to 4E illustrate tables of transmission power per time according to various embodiments;

FIG. 5 is a block diagram illustrating a plurality of transmission paths of an electronic device according to various embodiments;

FIG. 6A is a flowchart illustrating an operation method of an electronic device according to a comparative example for comparison with various embodiments;

FIG. 6B is a view illustrating a backoff according to a comparison example for comparison with various embodiments;

FIG. 7A is a flowchart illustrating an operation method of an electronic device according to various embodiments;

FIG. 7B is a view illustrating an MTPL for each RF path according to various embodiments;

FIG. 8 is a flowchart illustrating a method for operating an electronic device according to various embodiments;

FIG. 9A is a flowchart illustrating an operation method of an electronic device according to various embodiments;

FIG. 9B is a flowchart illustrating an operation method of an electronic device according to various embodiments;

FIG. 9C is a flowchart illustrating an operation method of an electronic device according to various embodiments;

FIG. 10 is a flowchart illustrating a method for operating an electronic device according to various embodiments;

FIG. 11 is a flowchart illustrating a method for operating an electronic device according to various embodiments;

FIG. 12 is a flowchart illustrating a method for operating an electronic device according to an embodiment;

FIG. 13 is a flowchart illustrating a method for operating an electronic device according to various embodiments;

FIG. 14 is a flowchart illustrating a method for operating an electronic device according to an embodiment of the present invention;

FIG. 15 is a flowchart illustrating a method for operating an electronic device according to an embodiment;

FIG. 16 is a flowchart illustrating a method for operating an electronic device according to various embodiments;

FIG. 17A is a view illustrating a time for determining whether an RF path is changed and/or an RF path change time according to a comparison example and various embodiments; and

FIGS. 17B and 17C are views illustrating a time for determining whether an RF path is changed and/or an RF path change time according to various embodiments.

### MODE FOR CARRYING OUT THE INVENTION

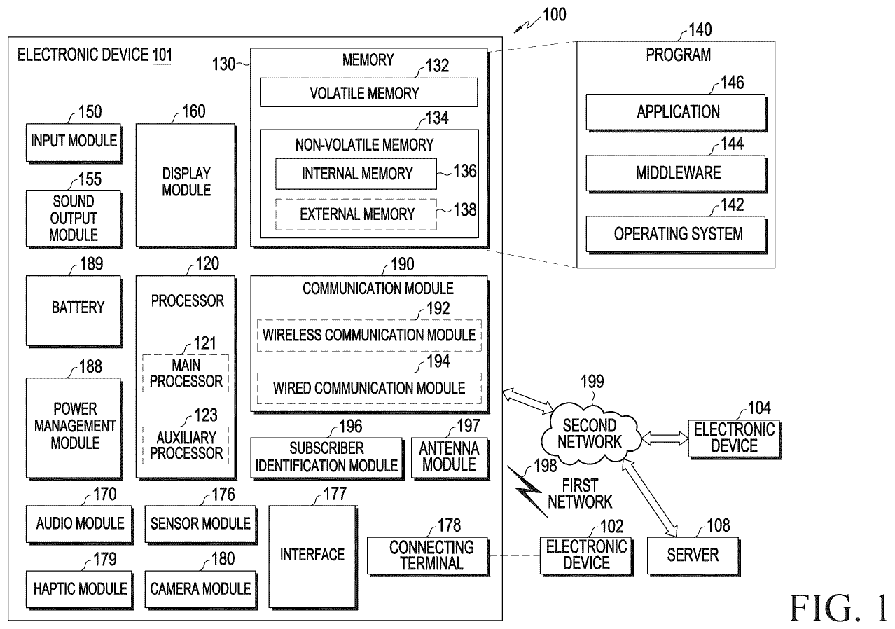

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

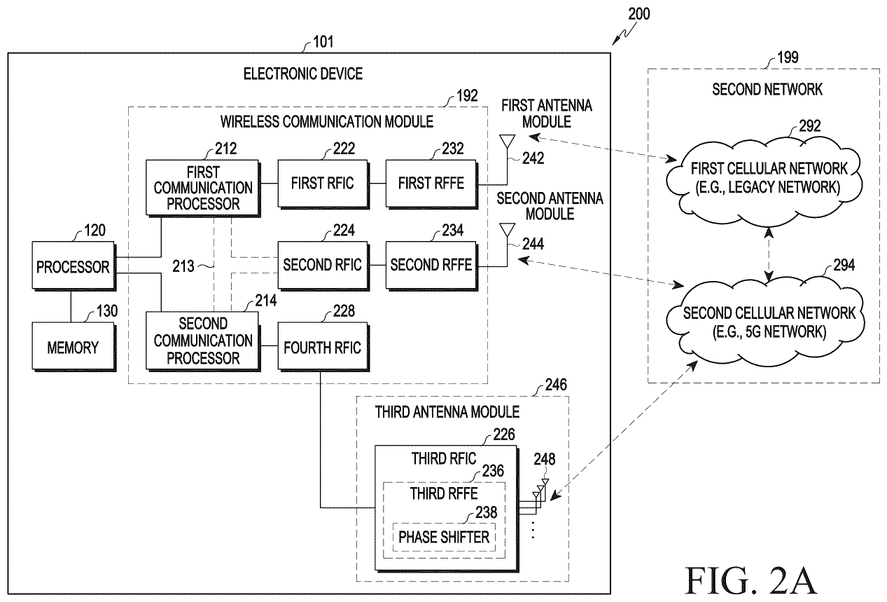

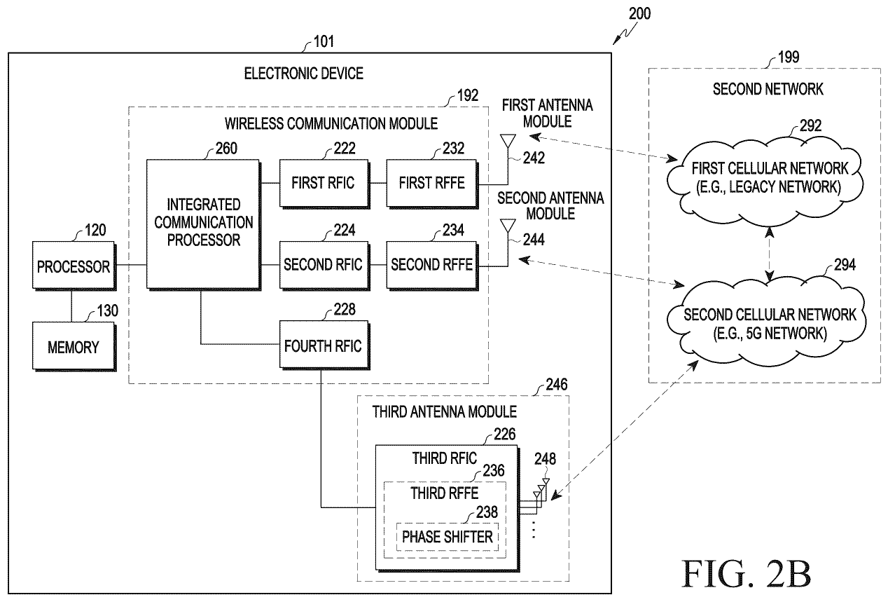

FIG. 2A is a block diagram 200 illustrating an electronic device 101 for supporting legacy network communication and 5G network communication according to various embodiments. With continued reference to FIG. 1 and with additional reference to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first communication processor 212 may establish a communication channel of a band that is to be used for wireless communication with the first cellular network 292 or may support legacy network communication via the established communication channel. According to various embodiments, the first cellular network may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first communication processor 212 or the second communication processor 214 may establish a communication channel corresponding to another designated band (e.g., about 6 GHz or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., a universal asynchronous receiver/transmitter (UART) (e.g., high speed-UART (HS-UART)) or a peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to an implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first communication processor 212 and the second communication processor 214 may be implemented in a single chip or a single package. According to an embodiment, the first communication processor 212 or the second communication processor 214, along with the processor 120, an assistance processor 123, or communication module 190, may be formed in a single chip or single package. For example, as shown in FIG. 2B, an integrated communication processor 260 may support all of the functions for communication with the first cellular network 292 and the second cellular network 294.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second communication processor 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to various embodiments, when the first RFIC 222 and the second RFIC 224 in FIG. 2A or FIG. 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on a same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of a high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

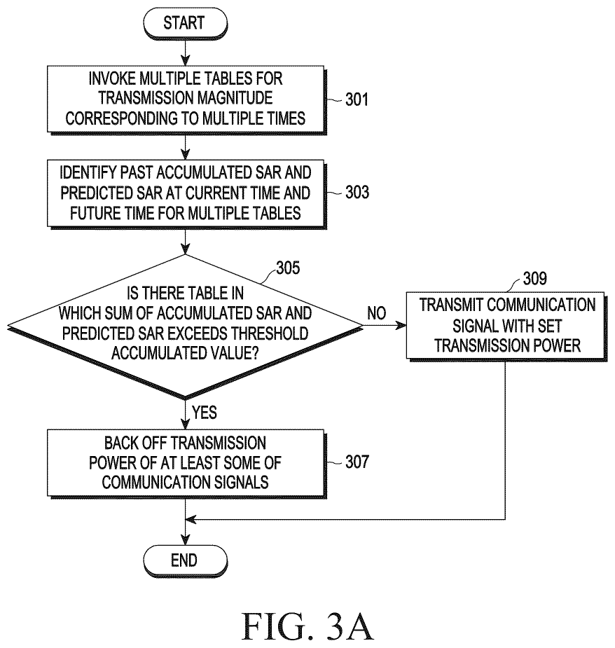

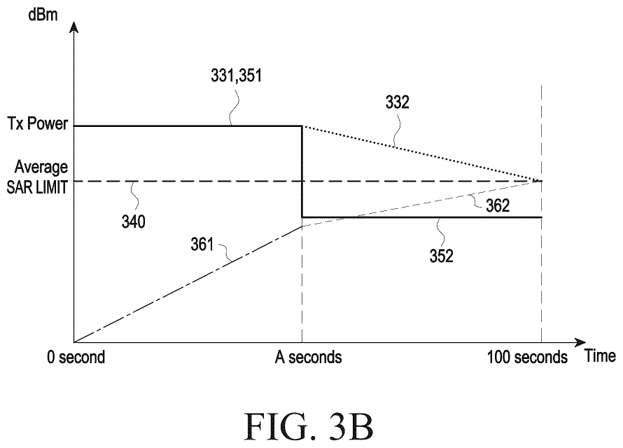

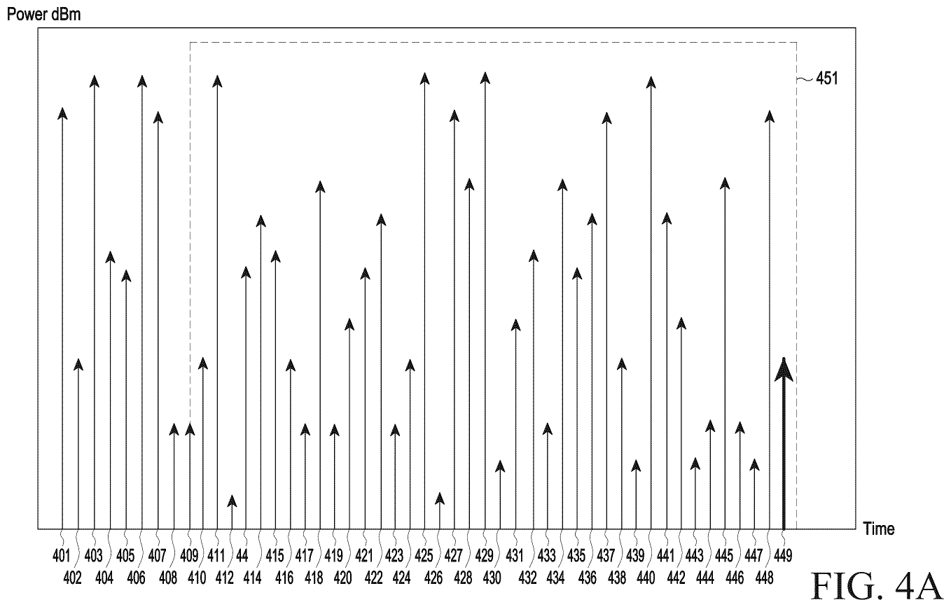

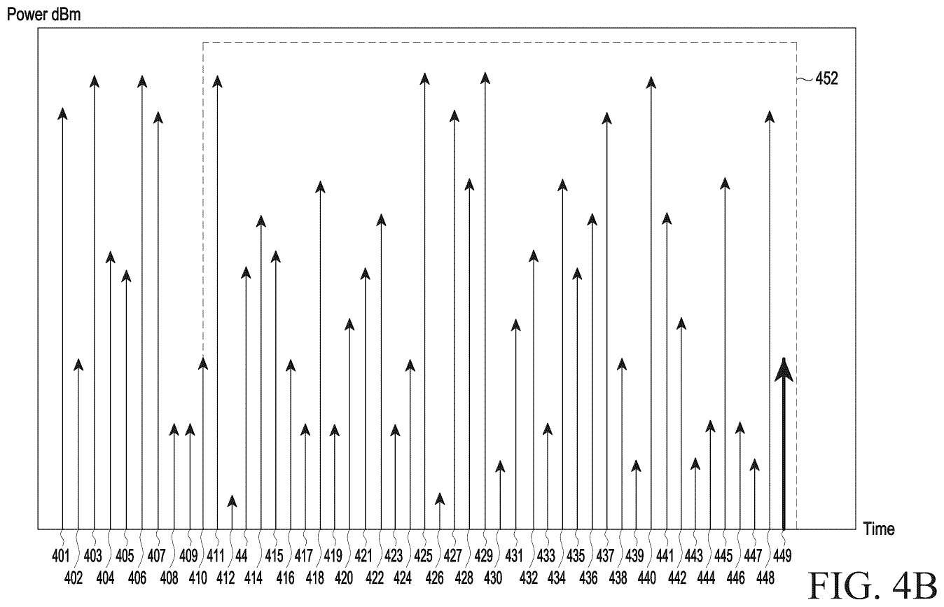

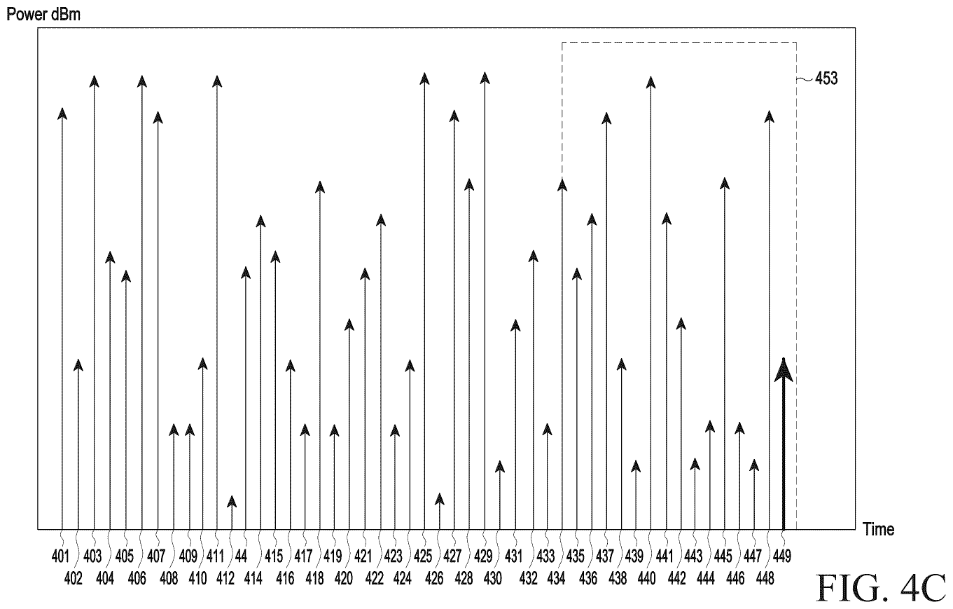

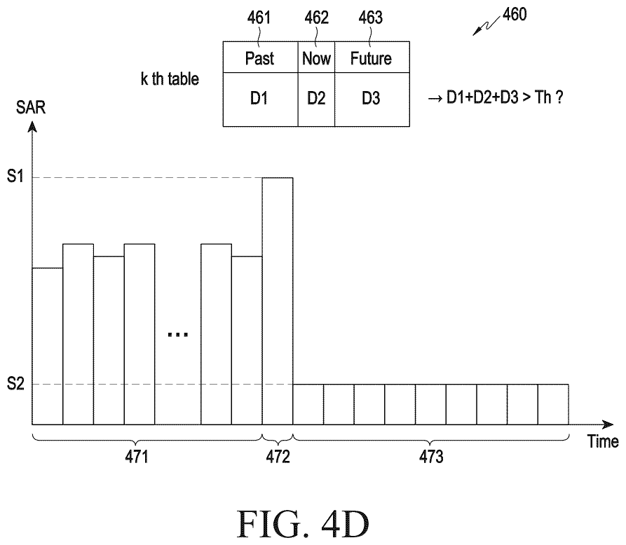

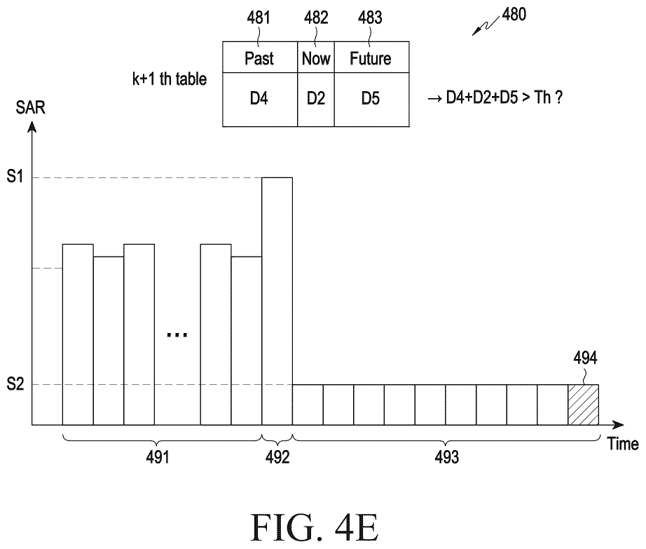

FIG. 3A is a flowchart illustrating an operation method of an electronic device according to various embodiments. The embodiment of FIG. 3A is described with reference to FIGS. 3B and FIGS. 4A to 4E. FIG. 3B is a view illustrating transmission power and SAR over unit time according to various embodiments. FIGS. 4A to 4C illustrate graphs of transmission power per unit time according to various embodiments. FIGS. 4D to 4E illustrate tables of transmission power per unit time according to various embodiments.

According to various embodiments, an electronic device 101 (e.g., at least one of the processor 120, the first communication processor 212, the second communication processor 214, or the integrated communication processor 260) may invoke a plurality of tables for the transmission power corresponding to a plurality of times in operation 301. Before describing the embodiment associated with FIG. 3A, terms as shown in Table 1 are defined.

TABLE 1
a. Normal MAX Power: the maximum transmission power when SAR margin remains
b. Normal Max SAR: the magnitude of SAR generated in normal MAX power
c. Backoff MAX Power: the maximum transmission power when back-off is performed
due to shortage of SAR margin
d. Backoff Max SAR: the magnitude of SAR generated when operating in backoff max
power
e. Measurement Time(T): period for calculating the accumulated SAR or SAR average
f. Measurement Period(P): period (or time interval) for calculating SAR
g. Number of tables for calculating SAR: T/P − 1
h. Average SAR LIMIT: the maximum value of the average SAR that should not be
exceeded during T
i. Average Time(A_Time): the time measured with SARs accumulated
j. Accumulated SAR: the sum of SARs accumulated for average time.
k. Max accumulated SAR: Average SAR LIMIT X measurement Time
l. Average SAR: the magnitude of average SAR used for average Time
m. Tx Room: Max accumulated SAR − accumulated SAR, SAR remaining after use
n. Remain Time(R_Time): total measurement time − time (A_Time) during which SAR
is measured up to now

First, the table is described with reference to FIGS. 4A to 4C. Referring to FIG. 4A, a graph including transmission power for a plurality of times 401 to 449 is illustrated. The accumulated SAR (the accumulated SAR of Table 1) for a measurement time (the measurement time of Table 1), e.g., a measurement time including 50 time points, may be required to maintain a value below the maximum accumulated SAR (the max accumulated SAR of Table 1). The electronic device 101 may determine the transmission power of a communication signal to be transmitted at the current time point 449 to allow the accumulated SAR of nine future time points (e.g., the remain time of Table 1) in addition to the accumulated SAR at the current time point 449 and any past time points 409 to 448 (e.g., the average time of Table 1) to maintain below the maximum accumulated SAR. Further, as shown in FIG. 4B, the electronic device 101 may identify the transmission powers 452 which are one time point shifted from the transmission powers 451 at the current time point 449 and any past time points 409 to 448. Shifting by one time point may mean not reflecting data at the oldest time point (e.g., time point 409 in FIG. 4A). The number of transmission powers 452 at the current time point 449 and any past time points 410 to 448 is 40 and may be one smaller than the number, 41, of the transmission powers 451 of FIG. 4A. The electronic device 101 may determine the transmission power at the current time point 449 to allow the sum of the SAR by the transmission powers 452 and the SAR predicted at additional future 10 time points to maintain the maximum accumulated SAR or less. As shown in FIG. 4C, the electronic device 101 may identify the transmission powers 453 at the current time point 449 and any past time points 434 to 448 which are 25 time point shifted from the transmission powers 451. The number of transmission powers 453 is 16 and may be 25 smaller than the number, 41, of the transmission powers 451 of FIG. 4A. The electronic device 101 may determine the transmission power at the current time point 449 to allow the sum of the SAR by the transmission powers 453 and the SAR predicted at additional future 34 time points to maintain the maximum accumulated SAR or less. Although not shown, the electronic device 101 may manage a plurality of graphs each of which is one time point shifted. The period of calculating the SAR is the measurement period P of Table 1 and may be, e.g., the interval between the transmission powers in FIGS. 4A to 4C. The electronic device 101 may calculate and/or manage T/P−1 tables at a specific point in time. Hereinafter, with reference to FIGS. 4D and 4E, a configuration for identifying an expected SAR value is described.

Referring to FIG. 4D, the electronic device 101 may identify the kth SAR table 460. The kth SAR table 460 may include D1, which is the accumulated SAR value 461 at least at one past time point, the maximum SAR value (D2) 462 at the current time, and the expected SAR value (D3) 463 at least at one future time point. Referring to the graph, the accumulated SAR value corresponding to the at least one past time point 461 may be D1. D1, which is the accumulated SAR value 461 at least at one past time point may be identified based on the antenna configuration. The number of the at least one past time point may be a number that is one smaller than the total number (e.g., 100) of time points corresponding to the measurement time (e.g., 50 seconds) in the first table. N, which is the total number (e.g., 100) of time points may be a result of dividing the measurement time by the sampling period (or shift period). Accordingly, in the kth SAR table 460, the number of at least one past time point may be k smaller than the total number of time points. The electronic device 101 may identify D1 which is the accumulated SAR value of the N-k past time points 471. The electronic device 101 may use the maximum SAR value S1 for the current time point 472. The maximum SAR value S1 (e.g., the normal max SAR in Table 1) may be the SAR value corresponding to a designated maximum transmission power (e.g., the normal max power of Table 1) in the electronic device 101. In another embodiment, for the current time point 472, the SAR value immediately before the current time point 472 may be used. In another embodiment, for the current time point 472, the average SAR value for the past time points 471 of the current time point 472 may be used. The electronic device 101 may calculate the sum of SAR values S2 (e.g., the backoff max SAR of Table 1) for the transmission power (e.g., the backoff max power of Table 1) backed off, for at least one future time point 473. The electronic device 101 may identify D3 as the accumulated SAR for at least one future time point 473. In the kth SAR table 460, the number of at least one future time point may be k−1. Accordingly, the electronic device 101 may identify whether the total SAR sum D1+D2+D3 for N time points including N-k past time points, one current time point, and k−1 future time points exceeds the maximum accumulated SAR, for the kth SAR table 460. Upon identifying the excess, the electronic device 101 may back off the transmission power of the current time point. Referring to FIG. 4E, the electronic device 101 may identify the k+1th table 480 as shown in FIG. 4E. For the k+1th table 480, the electronic device 101 may identify D4, which is the accumulated SAR value 481 of at least one past time point, D2, which is the maximum SAR value 482 of the current time point, and D5, which is the expected SAR value 483 of at least one future time point. The electronic device 101 may identify whether the accumulated SAR value of D4+D2+D5 exceeds the maximum accumulated SAR. The number of at least one past time point 491 in the k+1th table 480 may be one smaller than the number of at least one past time point 471 in the kth SAR table 460. The number of at least one future time point 493 in the k+1th table 480 may be one (494) larger than the number of at least one future time point 473 in the kth SAR table 460.

According to various embodiments, in operation 303, the electronic device 101 may identify the past accumulated SAR value and the expected SAR value at the current time point and future time point for a plurality of tables corresponding to at least one future time point. The electronic device 101 may identify the accumulated SAR value for a first table and a total of N−1 tables, which are shifted by i time points (where i is 1 or more and less than N−2) from the first table. In operation 305, the electronic device 101 may identify whether there is a table in which the sum of the accumulated SAR value and the expected SAR value exceeds a threshold. If there is a table exceeding the threshold (yes in 305), the electronic device 101 may back off any one (or the maximum transmission power level (MTPL)) of at least some transmission powers of the communication signals in operation 307. It will be appreciated by one of ordinary skill in the art that the back-off of transmission power may be replaced with back-off of MTPL in the disclosure. If there is no table exceeding the threshold (no in 305), the electronic device 101 may transmit a communication signal in the set transmission power in operation 309. The back-off of the maximum transmission power value may mean back-off of the maximum transmission power value in various embodiments of the disclosure.

As described above, the electronic device 101 may determine the maximum transmission power value so that the average SAR magnitude used during the measurement time does not exceed the average SAR limit or the electronic device 101 may determine the maximum transmission power value so that the accumulated SAR during the measurement time does not exceed the max accumulated SAR. The electronic device 101 may determine the maximum value of the maximum power for the next time period every time P. Conditions for operating in normal max power during next time P may be as follows.

Condition: Tx Room>SAR generated when operating in normal max power during next P (normal max SAR of Table 1)+SAR (backoff max SAR of Table 1) generated when operating in backoff max power during (Remain Time−P)=P×normal max SAR+(Remain Time−P)×backoff max SAR

In the condition, Tx Room may be the max accumulated SAR minus the SAR accumulated up to a current time. In the condition, (Remain Time−P) may be T−average time−P, e.g., the future time point described in connection with FIG. FIGS. 4A to 4E. P may mean the current time point. Average time may mean the past time point. Meeting (or, satisfying) the condition may mean that although the electronic device 101 sets the maximum transmission power of the normal max power during time P, there is no table in which the accumulated SAR exceeds the max accumulated SAR. Not meeting the condition may mean that there is a chance of presence of a table in which the accumulated SAR exceeds the max accumulated SAR if the electronic device 101 sets the maximum transmission power of the normal max power during time P, in which case the electronic device 101 may set the backoff max power as the maximum transmission power during time P.

Table 2 shows examples of variables and conditions.

TABLE 2
[Example of variable settings]

i. Normal MAX Power: 23 dBm
ii. Backoff MAX Power: 20 dBm
iii. Measurement Time(T): 100 seconds
iv. Measurement Period(P): 0.5 seconds
v. Number of SAR Calculator tables: 199
vi. Average SAR LIMIT: 1.5 mW/g
vii. Max accumulated SAR: 150 mW/g
viii. When Normal Max SAR => 23 dBm, SAR: 2 mW/g
ix. When Backoff Max SAR => 20 dBm, SAR: 1 mW/g

[Time when maximum power switches from normal max
power to backoff max power]

Average time X normal max power + (100 − average time) ×
backoff max power <= time when accumulated max SAR is met =
Average time × 2 mW/g + (100 − average time) × 1 mW/g <=
150 mW/g <=> Average time <= 50

In the example of Table 2, it is described that continuous use of the normal max power in the maximum transmission power for 50 seconds is possible and, after 50 seconds, back-off to the backoff max power is required. For example, it is hypothesized to transmit an RF signal in 23 dBm which is the normal max power, for 50 seconds, transmit an RF signal in 23 dBm which is the normal max power for the next P (0.5 seconds), and transmit an RF signal in 20 dBm which is the backoff max power for 49.5 seconds which is (remain time−P). In this case, Tx Room may be 150 mW/g−50×2 mW/g, i.e., 50 mW/g. The SAR generated for time P may be 2 mW/g×0.5 seconds, i.e., 1 mW/g. The SAR generated during (remain time−P) may be 49.5 seconds×1 mW/g, i.e., 49.5 mW/g. In this case, it may be identified that the accumulated SAR during P and (remain time−P) is 50.5 mW/g which exceeds the Tx room, and thus, it is required to back off the maximum value of the transmission power at time P. The above-described example is described with reference to FIG. 3B which describes the transmission power associated with one RAT. For example, referring to FIG. 3B, up to A seconds (e.g., 50 seconds), the maximum transmission power may be set to the normal max power 351 but, after A seconds, it may be identified to be backed off to the backoff max power 352. The slope of the second portion 362 of the accumulated SAR may be formed to be smaller than the slope of the first portion 361 of the accumulated SAR according to the backoff of the maximum value of the maximum transmission power. Although the average SAR 331 before A seconds exceeds the average SAR limit 340, it may be identified that the average SAR 332 is the same as the value of the average SAR limit 340 at a time point of 100 seconds according to the backoff. Meanwhile, as is described below, such an occasion where the electronic device 101 transmits RF signals for two or more RATs may occur. For example, the electronic device 101 may transmit a first RF signal based on E-UTRA and a second RF signal based on NR according to EN-DC. In this case, the electronic device 101 may back off the maximum value of the transmission power of the RF signal so that the accumulated SAR does not exceed the accumulated max SAR. The electronic device 101 may set the priority of the RAT to be backed off. For example, the electronic device 101 may be configured to preferentially back off the transmission power of the RF signal based on NR, which is the RAT corresponding to the SCG, rather than E-UTRA, which is the RAT corresponding to the MCG. Meanwhile, EN-DC is exemplary, and if it is NE-DC, the electronic device 101 may be configured to preferentially back off the maximum value of the transmission power of the RF signal based on the E-UTRA. In DC, it is also exemplary to preferentially back off the maximum value of the transmission power of the RF signal based on the SCG, and the priority of the backoff is not limited.

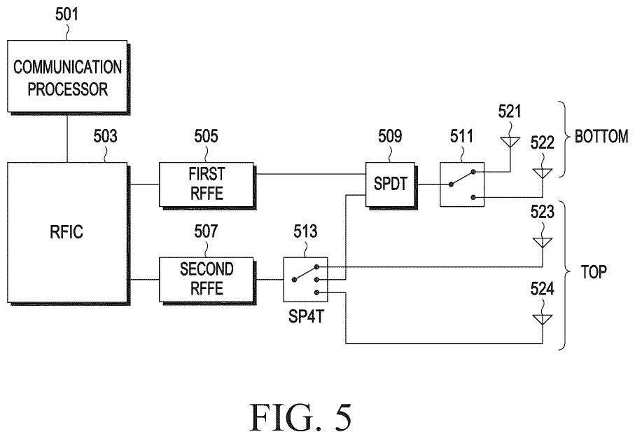

FIG. 5 is a block diagram illustrating a plurality of transmission paths of an electronic device according to various embodiments.

According to various embodiments, the communication processor (e.g., at least one of the first communication processor 212, the second communication processor 214, or the integrated communication processor 260) may transmit and/or receive a baseband signal to/from an RFIC 503 (e.g., at least one of the first RFIC 222, the second RFIC 224, the third RFIC 226, or the fourth RFIC 228). The RFIC 503 may process RF signals corresponding to, e.g., two or more RF paths. Here, the RF path may include, e.g., at least one piece of hardware (e.g., at least one of an RFIC, RFFE, or antenna) for transmitting an RF signal. For example, the RFCI 503 may receive two or more baseband signals from the communication processor 501 and generate two or more RF signals respectively corresponding thereto. The two or more RF signals may have different frequency bands, e.g., but are not limited thereto. At least one of generating, providing, or inputting to the antenna two or more RF signals may be performed to overlap at least partially, which may be referred to as 2 TX. It will be appreciated by one of ordinary skill in the art that although the RFIC 503 is shown as one module in the example of FIG. 5, this is an example, and the RFIC 503 may be implemented as a plurality of modules for the respective RF signals. Two or more RF signals may be generated, e.g., based on the MRDC or NEDC or ENDC or based on dual-sim DSDA mode, and there is no limit to the types of multiple RF signals.

According to various embodiments, the RFIC 503 may provide a first RF signal to the first RFFE 505. The RFIC 503 may provide a second RF signal to the second RFFE 507. The first RFFE 505 may process (e.g., amplify) and provide the received first RF signal. The second RFFE 507 may process (e.g., amplify) and provide the received second RF signal. For example, the first and second RFFEs 505 and 507 may amplify received RF signals to a degree of amplification determined by outside control (e.g., the communication processor 501). The communication processor 501 may determine the amplification degree of the first and second RFFEs 505 and 507 based on the maximum transmission power limit and/or transmission power determined as described above. Although not shown, the amplification degree of the first and second RFFEs 505 and 507 may be controlled based on an average power tracking (APT) module and/or an envelope tracking (ET) module. According to various embodiments, one RFFE may process a plurality of RF signals, such as where the first RFFE 505 processes a plurality of RF signals and the second RFFE 507 processes a plurality of signals.

According to various embodiments, the first RFFE 505 may be connected to a single pole double throw (SPDT) switch 509, and an output terminal of the SPDT switch 509 may be connected to the switch 511. The switch 511 may be configured to selectively connect the output terminal of the SPDT switch 509 to either the first antenna 521 or the second antenna 522. The second RFFE 507 may be connected to a single pole 4 throw (SP4T) switch 513. The SP4T switch 513 may be configured to selectively connect the output end of the second RFFE 507 to any one of the SPDT switch 509, the third antenna 523, or the fourth antenna 524. Meanwhile, the antennas 521, 522, 523, and 524 may be disposed, e.g., on the outer surface of the housing of the electronic device 101, but is not limited thereto. In one example, it may be hypothesized that the antennas 521 and 522 may be disposed on one side (e.g., upper end) of the housing of the electronic device 101, and the antennas 523 and 524 may be disposed on the other side (e.g., lower end) of the housing of the electronic device 101. In this case, the distance between the antennas 521 and 522 may be shorter than the distance between the first antenna 521 and the third antenna 523, the distance between the first antenna 521 and the fourth antenna 524, the distance between the second antenna 522 and the third antenna 523, or the distance between the second antenna 522 and the fourth antenna 524. The distance between the antennas 523 and 524 may be shorter than the distance between the third antenna 523 and the first antenna 521, the distance between the third antenna 523 and the second antenna 522, the distance between the fourth antenna 524 and the first antenna 521, or the distance between the fourth antenna 524 and the second antenna 522. Meanwhile, two RF signals may be at least partially simultaneously input to one antenna. For example, the RF signal of the B5 frequency band and the RF signal of the N2 frequency band may be at least partially simultaneously input to the first antenna 521.

For example, whether it is determined whether the SAR limits are violated based on the sum of exposures (e.g., SARs and/or PDs) generated by the antennas 521, 522, 523, and 524 or it is determined whether the SAR limits are violated independently from the exposures generated by the antennas 521, 522, 523, and 524 may be determined by Equation 1 below.

$${( {SAR}_{1} + {SAR}_{2} )}^{1.5} / R \leq 0.04 \qquad [ Equation 1 ]$$

In Equation 1, SAR₁ may be the SAR generated by one antenna, and SAR₂ may be the SAR generated by another antenna, and their unit may be, e.g., W/kg. R for the sum of various SARs may be shown in Table 3, for example. Meanwhile, the values, 1.5 and 0.04, in Equation 1 are merely exemplary and are not limited thereto.

TABLE 3

| | Minimum separation distance |
|---|---|
| Sum of SARs (SAR₁ + SAR₂) (W/Kg) | (minimum value of R) (mm) |
| 3.2 | 143 |
| 2.8 | 117 |
| 2.4 | 93 |
| 2 | 71 |
| 1.6 | 51 |
| 1.4 | 41 |
| 1.2 | 33 |
| 1.0 | 25 |
| 0.8 | 18 |

For example, it is hypothesized that in 2TX, the sum of SARs generated from the third antenna 523 and the fourth antenna 524 is 3.2 W/Kg. Meanwhile, as the third antenna 523 and the fourth antenna 524 both are disposed at an upper end of the electronic device 101, the spacing may be less than 143 mm. In this case, to determine whether the SAR rule is instantaneously violated or the accumulated SAR rule is violated by the electronic device 101, it may be required to determine whether the sum of SARs generated from the third antenna 523 and the fourth antenna 524 violates the SAR rule. Meanwhile, it is hypothesized that in 2TX, the sum of SARs generated from the third antenna 523 and the first antenna 521 is 3.2 W/Kg. Meanwhile, as the third antenna 523 and the first antenna 521, respectively, are disposed at an upper end and lower end of the electronic device 101, the spacing may be 143 mm or more. In this case, to determine whether the SAR rule is instantaneously violated or the accumulated SAR rule is violated by the electronic device 101, it may be required to determine whether the sum of SARs generated from the third antenna 523 violates the SAR rule and/or whether the sum of SARs generated from the first antenna 521 violates the SAR rule.

As described above, it may be expressed that the antennas (e.g., the pair of the first antenna 521 and the second antenna 522 or the pair of the third antenna 523 and the fourth antenna 524) where the sum of the SARs is considered to determine whether the SAR rule is violated according to satisfaction of Equation 1 are included in the same antenna group. When the distance between antennas is relatively small (e.g., smaller than the distance related to Equation 1), they may be included in the same antenna group. Further, it may be expressed that the antennas (e.g., the pair of the first antenna 521 and the third antenna 522, the pair of the first antenna 521 and the fourth antenna 524, the pair of the second antenna 522 and the third antenna 522, or the pair of the second antenna 522 and the fourth antenna 524) where independent SARs are considered, rather than the sum of the SARs, are considered to determine whether the SAR rule is violated according to failure to meet Equation 1 are included in different antenna groups. When the distance between antennas is relatively large (e.g., larger than the distance related to Equation 1), they may be included in different antenna groups.

When it is determined whether to back off the MTPL based on the accumulated SAR (or average SAR), the backoff of the MTPL for at least one antenna when the antennas for 2TX are included in the same antenna group may be performed earlier than the backoff of the MTPL for at least one antenna when the antennas for 2TX are included in different antenna groups. As described above, when the sum of the accumulated SAR and the predicted SAR at the current time and/or the future time exceeds the Max accumulated SAR, the backoff of the MTPL at the current time may be performed. If the antennas are included in the same antenna group, the sum of the SARs expected at the current time and/or the future time may be set to the sum of the SARs expected at the current time and/or the future time for one antenna and the sum of the SARs expected at the current time and/or the future time for another antenna. Accordingly, when the sum of the accumulated SAR for both the antennas, the SAR expected at the current time and/or the future time for one antenna, and the SAR expected at the current time and/or the future time for the other antenna exceeds the Max accumulated SAR, the backoff of the MTPL at the current time may be performed. Meanwhile, when the antennas are included in different antenna groups, the backoff of the MTPL at the current time may be performed if the sum of the accumulated SAR for one antenna, and the predicted SAR at the current time and/or the future time for one antenna exceeds the Max accumulated SAR, or if the sum of the accumulated SAR for the other antenna, and the predicted SAR at the current time and/or the future time for the other antenna exceeds the Max accumulated SAR, the backoff of the MTPL at the current time may be performed. Accordingly, the backoff of the MTPL for at least one antenna when the antennas for 2TX are included in the same antenna group may be performed earlier than the backoff of the MTPL for at least one antenna when the antennas for 2TX are included in different antenna groups. The electronic device 101 according to various embodiments may perform 2TX using antennas of different antenna groups by changing any one RF path of 2TX before performing backoff on any one RF path while performing 2TX using antennas of the same antenna group. Accordingly, the backoff time for any one RF path may be delayed or the backoff may not be performed, so that more stable communication may be possible. In one example, the electronic device 101 may transmit a plurality of RF signals using antennas included in the same antenna group at an initial time. This may be due to a smaller RF path loss of RF paths corresponding to antennas of any one antenna group, but the cause is not limited thereto.

For example, in FIG. 5, it is hypothesized that the electronic device 101 transmits the first RF signal of the B5 frequency band and the second RF signal of the N2 frequency band using the first antenna 521. In this case, since two RF signals are transmitted by one antenna, the backoff of the MTPL at the current time may be performed when the sum of the accumulated SAR of the first RF signal, the accumulated SAR of the second RF signal, the predicted SAR at the current time and/or the future time of the first RF signal, and the predicted SAR at the current time and/or the future time of the second RF signal exceeds the Max accumulated SAR according to 2TX based on the same antenna group. Accordingly, it is possible to perform backoff on at least one RF path relatively early. According to various embodiments, the electronic device 101 may change the RF path of the second RF signal before the backoff is performed on the specific RF path. For example, the electronic device 101 may maintain transmission of the first RF signal of the B5 frequency band through the first antenna 521, but may change the RF path so that the second RF signal of the N2 frequency band is transmitted using the third antenna 523. Thereafter, for the first RF signal, the backoff of MTPL at the current time may be performed when the sum of the accumulated SAR of the first RF signal, the accumulated SAR of the second RF signal, and the predicted SAR at the current time and/or the future time of the first RF signal exceeds the Max accumulated SAR. Accordingly, the time of backoff for the first RF signal may be delayed, or the backoff may not be performed. Further, for the third antenna 523, since it lacks previous RF signal transmission, the backoff of the MTPL at the current time may be performed when the sum of the SARs expected at the current time and/or the future time of the second RF signal exceeds the Max cumulative SAR. Accordingly, through the third antenna 523, the backoff of the MTPL at the current time is performed, and the backoff may be performed at a relatively late time even at the future time or may not be performed. The change of the RF path described above may be performed by changing the path from the RFFE to the antenna (e.g., controlling at least one of the switches 511 and 513) without changing the RFFE, which may be referred to as antenna switching diversity (ASdiv). Alternatively, the change of the RF path may be performed based on a change of the RF circuit (e.g., RFIC and/or RFFE) processing the corresponding RF signal (or additionally, a change by antenna control), which may be referred to as Tx hopping. It will be understood by one of ordinary skill in the art that the change of the RF path in the disclosure may be performed by ASdiv and/or Tx hopping, or other methods, and the method of performing the change is not limited.

As described above, it is possible to stably perform communication by being able to perform transmission of a plurality of RF signals through the antennas included in different antenna groups rather than performing backoff on a specific RF signal during transmission of a plurality of RF signals by the antennas included in the same antenna group.

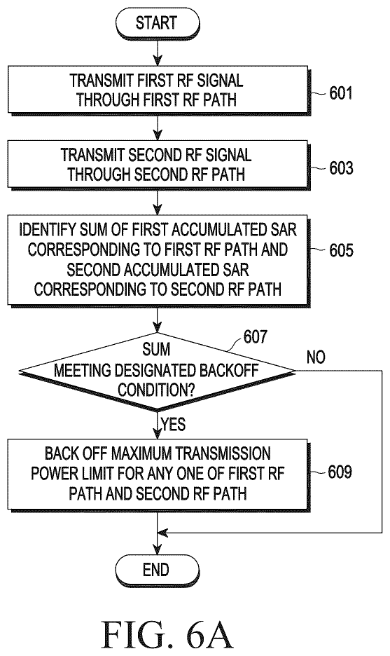

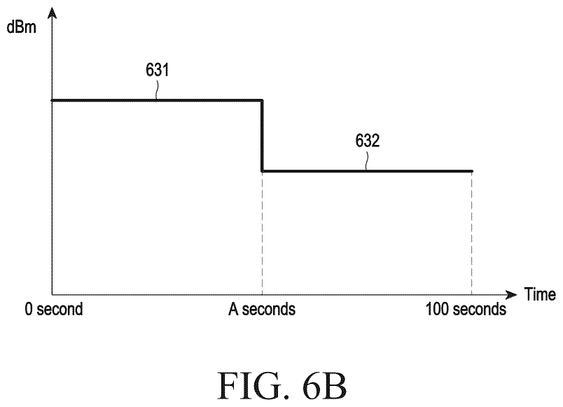

FIG. 6A is a flowchart illustrating an operation method of an electronic device according to a comparative example for comparison with various embodiments. At least some of the operations performed by the electronic device according to the comparative example may also be performed by the electronic device according to various embodiments. The embodiment of FIG. 6A is described with reference to FIG. 6B. FIG. 6B is a view illustrating a backoff according to a comparison example for comparison with various embodiments.

In operation 601, the electronic device 101 may transmit a first RF signal through a first RF path. In operation 603, the electronic device 101 may transmit a second RF signal through a second RF path. In the example of FIG. 6A, although the first RF path and the second RF path are illustrated as being different, RF signals may be transmitted through the same RF path (or through the same antenna). In the example of FIG. 6A, it is hypothesized that the antenna corresponding to the first RF path and the antenna corresponding to the second RF path are included in the same antenna group. For example, referring to FIG. 6B, the MTPL corresponding to the first RF signal may be a first value 631. In operation 605, the electronic device 101 may identify the sum of the first accumulated SAR corresponding to the first RF path and the second accumulated SAR corresponding to the second RF path. In operation 607, the electronic device 101 may identify whether the sum meets a designated backoff condition. For example, it may be identified whether the total sum of the first accumulated SAR corresponding to the first RF path and the second accumulated SAR corresponding to the second RF path, the predicted SAR at the current time and/or future time corresponding to the first RF path, and the predicted SAR at the current time and/or future time corresponding to the second RF path exceeds the Max accumulated SAR. If the designated backoff condition is met (Yes in operation 607), the electronic device 101 may back off the MTPL for any one of the first RF path and the second RF path in operation 609. For example, the electronic device 101 may determine to change the first RF path to another RF path. In this case, referring to FIG. 6B, it may be identified that the MTPL corresponding to the first RF signal is backed off from the first value 631 to the second value 632. As the MTPL decreases, communication stability may decrease.

Although FIG. 6A and the accompanying text refer to operations 601 and 603 in sequence, it is to be understood that this sequence is not necessary and that other embodiments exist. For example, the transmission of the second RF signal through the second RF path of operation 603 can precede the transmission of the first RF signal through the first RF path of operation 601 or, alternatively, the transmissions of the first and second RF signals through the first and second RF paths can be done in parallel with one another or can be simultaneous or at least partially simultaneous.

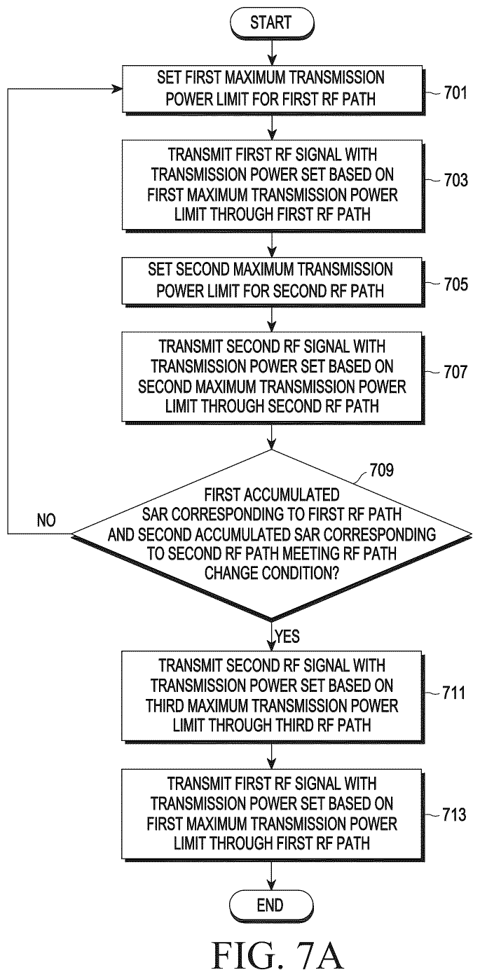

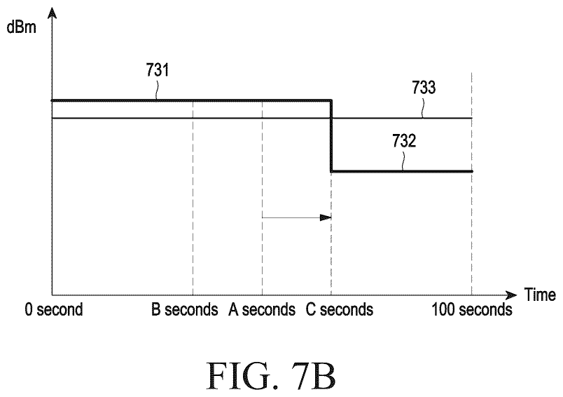

FIG. 7A is a flowchart illustrating an operation method of an electronic device according to various embodiments. The embodiment of FIG. 7A is described with reference to FIG. 7B. FIG. 7B is a view illustrating an MTPL for each RF path according to various embodiments.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 701. In operation 703, the electronic device 101 may transmit the first RF signal with transmission power set based on the first maximum transmission power limit through the first RF path. The transmission power of the first RF signal may be less than or equal to the first maximum transmission power limit. For example, the electronic device 101 may control an RF circuit (e.g., at least one RFIC and/or at least one RFFE associated with the first RF path) to transmit the first RF signal to the set transmission power in operation 703. In operation 705, the electronic device 101 may set a second maximum transmission power limit for the second RF path. In operation 707, the electronic device 101 may transmit the second RF signal with transmission power set based on the second maximum transmission power limit through the second RF path. The transmission power of the second RF signal may be less than or equal to the second maximum transmission power limit. For example, referring to FIG. 7B, the first maximum transmission power limit may be a first value 731, and the second maximum transmission power limit may be a third value 733. For example, the distance between the antenna corresponding to the first RF path and the antenna corresponding to the second RF path may be less than a threshold distance, and the first RF path and the second RF path may correspond to the same antenna group.

Although FIG. 7A and the accompanying text refer to operations 701-707 in sequence, it is to be understood that this sequence is not necessary and that other embodiments exist. For example, the setting of the first maximum transmission power limit for the first RF path of operation 701 and the setting of the second maximum transmission power limit for the second RF path of operation 705 can be executed in parallel with one another or at least partially simultaneously. Similarly, the transmission of the first RF signal with the first maximum transmission power limit through the first RF path of operation 703 and the transmission of the second RF signal with the second maximum transmission power limit through the second RF path of operation 707 can be executed in parallel with one another or at least partially simultaneously.

According to various embodiments, in operation 709, the electronic device 101 may identify whether the first accumulated SAR corresponding to the first RF path and the second accumulated SAR corresponding to the second RF path meet the RF path change condition. In one example, the electronic device 101 may identify whether the sum of the first accumulated SAR corresponding to the first RF path, the second accumulated SAR, the predicted SAR at the current time and/or future time corresponding to the first RF path, and the predicted SAR at the current time and/or future time corresponding to the second RF path exceeds a designated threshold as whether the RF path change condition is met. Here, the designated threshold may be a value smaller than the Max accumulated SAR for determining whether to back off. Alternatively, when the predicted SAR at the current time and/or future time corresponding to the first RF path and the predicted SAR at the current time and/or future time corresponding to the second RF path are fixed values, the electronic device 101 may identify whether the sum of the first accumulated SAR and the second accumulated SAR corresponding to the first RF path exceeds the threshold reflecting the above-described fixed values as whether the RF path change condition is met. The above-described RF path change condition is not limited as long as it is a condition in which at least one RF path is changed before the backoff is performed so that the antennas are included in different antenna groups to delay the backoff time or not perform the backoff. Meanwhile, the SAR as used herein is exemplary, and it will be understood by one of ordinary skill in the art that if the RF signal is an mmWave signal, it may be replaced with a power density (PD).

According to various embodiments, if it is identified that the RF path change condition is met (Yes in 709), the electronic device 101 may transmit the second RF signal through the third RF path at the transmission power set based on the third maximum transmission power limit in operation 711. Here, the third maximum transmission power limit may be, e.g., the same value as the second maximum transmission power limit or, in some cases, may be different values. The third RF path may be determined so that the antenna corresponding to the third RF path may be included in an antenna group different from the antenna corresponding to the first RF path. For example, the distance between the antenna corresponding to the third RF path and the antenna corresponding to the first RF path may be larger than or equal to a threshold distance, and the third RF path and the first RF path may correspond to different antenna groups. It will be understood by one of ordinary skill in the art that the transmission of the second RF signal in operation 711 means a signal subsequent to the second RF signal in operation 707, rather than transmitting the same signal as the second RF signal in operation 707. In operation 713, the electronic device 101 may transmit the first RF signal with transmission power set based on the first maximum transmission power limit through the first RF path. The electronic device 101 may not back off the maximum transmission power limit corresponding to the first RF path. For example, referring to FIG. 7B, the electronic device 101 may identify that the RF path change condition is met, e.g., at B seconds. As described above, the threshold associated with the RF path change condition may be a value smaller than the Max cumulative SAR set for backoff, and accordingly, the RF path change condition may be met at B seconds which are earlier than the A seconds at which the backoff is performed in FIG. 6B. At the B seconds, the electronic device 101 may change the RF path of the second RF signal from the second RF path to the third RF path based on satisfaction of the RF path change condition. As described above, the maximum transmission power limit for the third RF path may be the same as or different from the maximum transmission power limit of the existing second RF path. In the embodiment of FIG. 6B, it is illustrated that the maximum transmission power limit for the third RF path is the same as the maximum transmission power limit for the existing second RF path as the third value 733, but as described above, this is exemplary and both the values may be different. Meanwhile, accordingly, the maximum transmission power limit corresponding to the first RF path may be maintained as the first value 731. Thereafter, at C seconds, the backoff condition for the first RF path may be met. This is because, as the antenna of the first RF path and the antenna of the third RF path belong to different antenna groups, only the SAR corresponding to the first RF path is considered to determine whether the first RF path is backed off after B seconds. In this case, the electronic device 101 may reduce the maximum transmission power limit for the first RF path from the first value 731 to the second value 732. Accordingly, it may be identified that the backoff is performed at C seconds later than the A seconds which is the backoff time in the comparison example. Further, in some cases, backoff may not be performed on the first RF path.

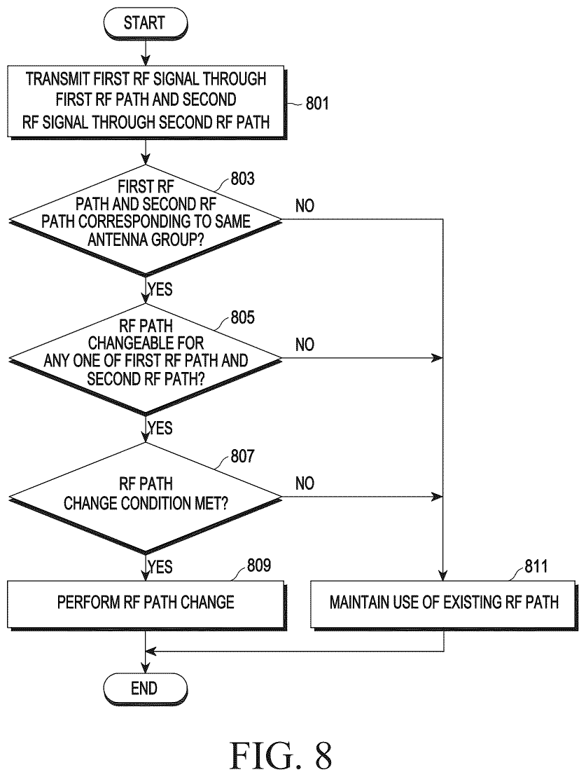

FIG. 8 is a flowchart illustrating a method for operating an electronic device according to various embodiments.

According to an embodiment, the electronic device 101 (e.g., at least one of the processor 120, the first communication processor 212, the second communication processor 214, the integrated communication processor 260, or the communication processor 501) may transmit a first RF signal through the first RF path and a second RF signal through the second RF path in operation 801. In operation 803, the electronic device 101 may identify whether the first RF path and the second RF path correspond to the same antenna group. As described above, when the physical distance between the antenna corresponding to the first RF path and the antenna corresponding to the second RF path and the SAR corresponding to the first RF path and the SAR corresponding to the second RF path meet Equation 1, the first RF path and the second RF path may correspond to the same antenna group, and when Equation 1 is not met, the first RF path and the second RF path may not correspond to the same antenna group. In one example, the electronic device 101 may determine whether they are in the same antenna group by determining whether Equation 1 is met. In another example, the electronic device 101 may manage an antenna group identifier or may manage an antenna group identifier included for each RF path. The method for determining whether the RF paths correspond to the same antenna group is not limited. If the RF paths correspond to different antenna groups (No in operation 803), the electronic device 101 may maintain the use of the existing RF path in operation 811. Further, if the backoff condition is met for any one RF path, the electronic device 101 may back off the MPTL of the at least one RF path while maintaining the use of the existing RF path.

According to various embodiments, when the RF paths correspond to the same antenna group (Yes in 803), the electronic device 101 may identify whether it is possible to change the RF path for any one of the first RF path and the second RF path in operation 805. If both the first RF path and the second RF path are unable to change the RF path (No in operation 805), the electronic device 101 may maintain the use of the existing RF path in operation 811. Further, if the backoff condition is met for any one RF path, the electronic device 101 may back off the MPTL of the at least one RF path while maintaining the use of the existing RF path. For example, the first RF signal of the first frequency band may be transmitted through the first RF path, and the second RF signal of the second frequency band may be transmitted through the second RF path. Since the RF path may process some frequency bands other than all the frequency bands, such an occasion may occur where the first RF signal of the first frequency band may not be provided through an RF path other than the first RF path, and/or the second RF signal of the second frequency band may not be provided through an RF path other than the second RF path. Alternatively, software may be configured so that the first RF signal of the first frequency band is not provided through an RF path other than the first RF path and/or the second RF signal of the second frequency band is not provided through an RF path other than the second RF path.

According to various embodiments, when it is possible to change the RF path for any one of the first RF path and the second RF path (Yes in operation 805), the electronic device 101 may identify whether the RF path change condition is met in operation 807. When the RF path change condition is met (Yes in operation 807), the electronic device 101 may change at least one RF path in operation 809. When the RF path change condition is not met (No in operation 807), the electronic device 101 may maintain the use of the existing RF path in operation 811. As described above, the electronic device 101 may identify whether the RF path change condition is met, based on the accumulated SAR for RF paths included in the same antenna group.

In one example, it is hypothesized that the first RF signal of the frequency band of B5 is transmitted through the first RF path, and the second RF signal of the frequency band of N2 is transmitted through the second RF path. The MTPL of the first RF signal may be 23 dBm, and in this case, an SAR of 1 mW/g may be generated, and the MTPL of the second RF signal may be 23 dBm, and in this case, an SAR of 1.8 mW/g may be generated. The electronic device 101 may identify whether the total sum of the accumulated SAR and the product of 2.8 mW/g which is the sum of the SARs of both the RF signals and the remaining times exceeds a threshold for RF path change set to be smaller than the Max accumulated SAR for one table. Or, the electronic device 101 may identify whether, for one table, the total sum of the accumulated SAR, 2.8 mW/g which is the sum of the SARs of both the RF signals corresponding to the SAR at the current time, and the SAR based on the backed-off MTPL corresponding to the SAR at the future time multiplied by the remaining time exceeds a threshold for RF path change set to be smaller than the Max accumulated SAR. When the total sum exceeds the threshold, the electronic device 101 may identify that the RF path change condition is met. Alternatively, the electronic device 101 may identify whether the RF path change is met, based simply on whether the accumulated SAR exceeds another threshold.

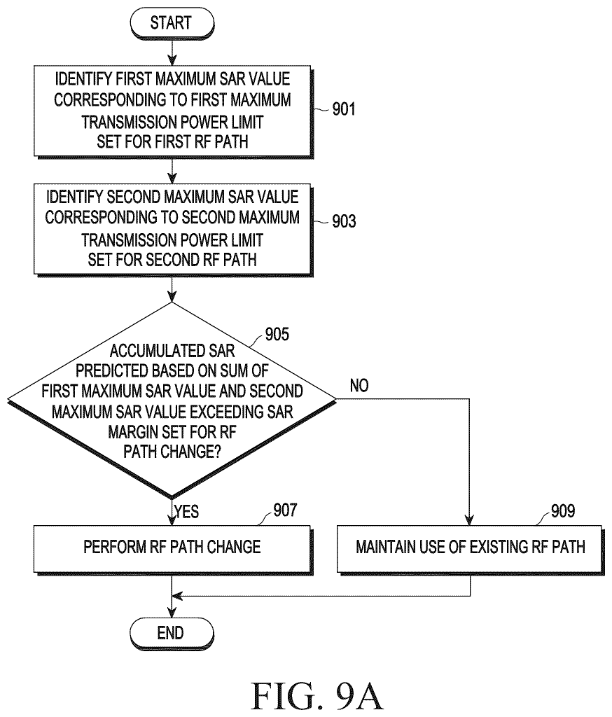

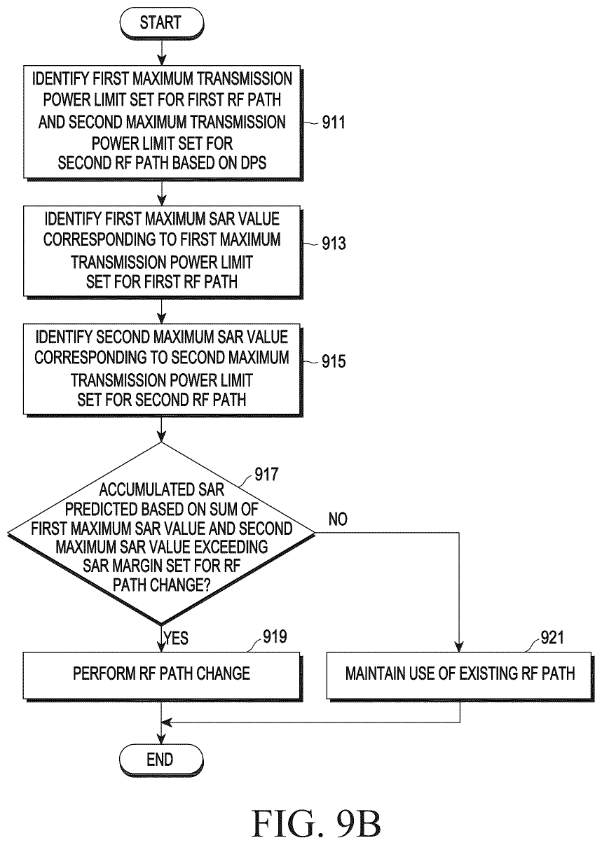

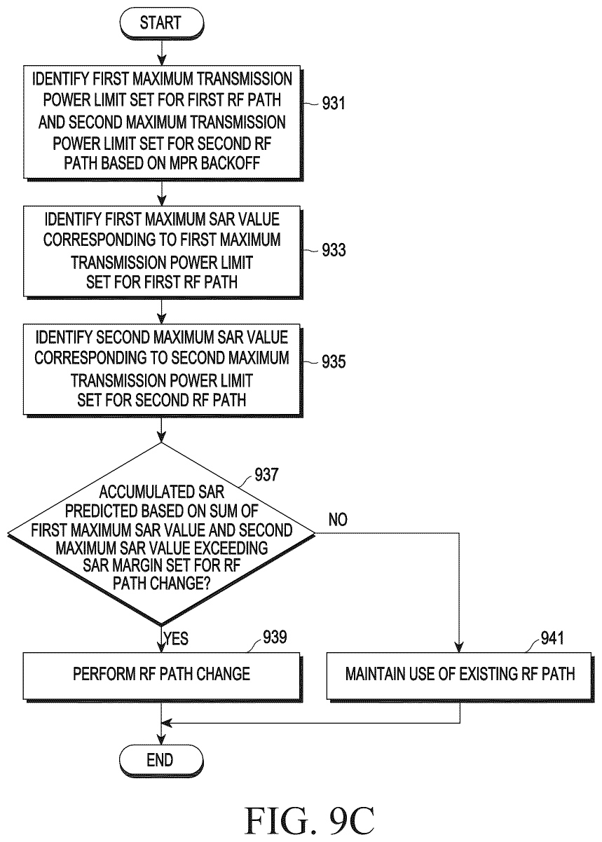

FIG. 9A is a flowchart illustrating an operation method of an electronic device according to various embodiments.

According to an embodiment, the electronic device 101 (e.g., at least one of the processor 120, the first communication processor 212, the second communication processor 214, the integrated communication processor 260, or the communication processor 501) may identify a first SAR maximum value corresponding to a first maximum transmission power limit set for the first RF path in operation 901. In operation 903, the electronic device 101 may identify the second SAR maximum value corresponding to the second maximum transmission power limit set for the second RF path. In operation 905, the electronic device 101 may identify whether the accumulated amount of SAR predicted based on the sum of the first SAR maximum value and the second SAR maximum value exceeds an SAR margin set for RF path change. The predicted accumulated SAR may be, e.g., a value obtained by multiplying the sum of the first SAR maximum value and the second SAR maximum value by the remaining times, but is not limited thereto. Here, the SAR margin may be, e.g., a value obtained by subtracting the already generated accumulated SAR value at the RF paths from a threshold for RF path change, and for example, the SAR margin may be set so that the backoff corresponding to the RF signal in which the RF path is maintained is delayed or the backoff is not performed, but is not limited thereto. If the predicted accumulated SAR exceeds the SAR margin set for RF path change (Yes in operation 905), the electronic device 101 may change at least one RF path in operation 907. If the predicted accumulated SAR is less than or equal to the SAR margin set for RF path change (No in operation 905), the electronic device 101 may maintain the use of the existing RF path in operation 909.

Although FIG. 9A and the accompanying text refer to operations 901 and 903 in sequence, it is to be understood that this sequence is not necessary and that other embodiments exist. For example, the identifying of the second maximum SAR value corresponding to the second maximum transmission power limit set for the second RF path of operation 903 can precede the identifying of the first maximum SAR value corresponding to the first maximum transmission power limit set for the first RF path of operation 901 or, alternatively, the identifying of the first and second maximum SAR values corresponding to the first and second maximum transmission power limits set for the first and second RF paths can be done in parallel with one another or can be simultaneous or at least partially simultaneous.

FIG. 9B is a flowchart illustrating an operation method of an electronic device according to various embodiments.

According to an embodiment, the electronic device 101 (e.g., at least one of the processor 120, the first communication processor 212, the second communication processor 214, the integrated communication processor 260, or the communication processor 501) may identify a first maximum transmission power limit set for the first RF path and a second maximum transmission power limit set for the second RF path based on dynamic power sharing (DPS) in operation 911. For example, when the frequency band of B5 and the frequency band of N2 are used, the maximum transmission power limit corresponding to the frequency band of B5 when DPS is not considered may be 23 dBm, and the maximum transmission power limit corresponding to the frequency band of N2 may be 23 dBm. Meanwhile, when two or more RATs such as MR DC are used, the electronic device 101 may manage the allowable maximum transmission power limit, e.g., 24 dBm. In this case, the maximum transmission power limits may be reset so that the sum of the maximum transmission power limits of both RATs is 24 dBm or less. In operation 913, the electronic device 101 may identify a first SAR maximum value corresponding to a first maximum transmission power limit set for the first RF path. In operation 915, the electronic device 101 may identify a second SAR maximum value corresponding to a second maximum transmission power limit set for the second RF path. For example, as the maximum transmission power limit of the frequency band of B5 is set to 23 dBm and the maximum transmission power limit of the frequency band of N2 is set to 17.1 dBm, 24 dBm, which is the maximum transmission power sum based on the DPS, is met. In this case, the SAR generated corresponding to the frequency band of B5 may be 1.0 mW/g and the SAR generated corresponding to the frequency band of N2 may be 0.46 mW/g. For example, as the maximum transmission power limit of the frequency band of B5 is set to 17.1 dBm and the maximum transmission power limit of the frequency band of N2 is set to 23 dBm, 24 dBm, which is the maximum transmission power sum based on the DPS, is met. In this case, the SAR generated corresponding to the frequency band of B5 may be 0.26 mW/g and the SAR generated corresponding to the frequency band of N2 may be 1.8 mW/g. In this case, the maximum SAR corresponding to the maximum transmission power limit may be 2.06 mW/g of 0.26+1.8.

Although FIG. 9B and the accompanying text refer to operations 913 and 915 in sequence, it is to be understood that this sequence is not necessary and that other embodiments exist. For example, the identifying of the second maximum SAR value corresponding to the second maximum transmission power limit set for the second RF path of operation 915 can precede the identifying of the first maximum SAR value corresponding to the first maximum transmission power limit set for the first RF path of operation 913 or, alternatively, the identifying of the first and second maximum SAR values corresponding to the first and second maximum transmission power limits set for the first and second RF paths can be done in parallel with one another or can be simultaneous or at least partially simultaneous.

According to various embodiments, in operation 917, the electronic device 101 may identify whether the predicted accumulated SAR, based on the sum of the first SAR maximum value and the second SAR maximum value, exceeds the SAR margin set to change the RF path. For example, the electronic device 101 may identify whether the product of 2.06 mW/g and the remaining time exceeds the SAR margin set for RF path change. When the accumulated SAR predicted based on the sum of the first SAR maximum value and the second SAR maximum value exceeds the SAR margin set for RF path change (Yes in operation 917), the electronic device 101 may change at least one RF path in operation 919. When the accumulated SAR predicted based on the sum of the first SAR maximum value and the second SAR maximum value is less than or equal to the SAR margin set for RF path change (No in operation 917), the electronic device 101 may maintain the use of the existing RF path in operation 921.

FIG. 9C is a flowchart illustrating an operation method of an electronic device according to various embodiments.

According to an embodiment, the electronic device 101 (e.g., at least one of the processor 120, the first communication processor 212, the second communication processor 214, the integrated communication processor 260, or the communication processor 501) may identify a first maximum transmission power limit set for the first RF path and a second maximum transmission power limit set for the second RF path based on maximum power reduction (MPR) backoff in operation 921. In operation 933, the electronic device 101 may identify the first SAR maximum value corresponding to the first maximum transmission power limit set for the first RF path. In operation 935, the electronic device 101 may identify the second SAR maximum value corresponding to the second maximum transmission power limit set for the second RF path. For example, the electronic device 101 may set the MPR backoff value depending on whether at least one of the first RF path and/or the second RF path is CP OFDM or DFT-s-OFDM. For example, the electronic device 101 may set the MPR backoff value based on the modulation type of at least one of the first RF path and/or the second RF path. For example, the electronic device 101 may set the MPR backoff value based on whether at least one of the first RF path and/or the second RF path corresponds to an inner RB or an outer RB. For example, when the frequency band of N2 is CP OFDM and corresponds to 256 QAM, the MPR may be set to 6.5 dB when the electronic device 101 is in power class 3, and accordingly, a maximum transmission power limit of 16.5 dBm in which 6.5 dB is set to 23 dBm may be set. The MPR may be set for each power class by 3GPP, e.g., but is not limited thereto. The SAR maximum value corresponding to 16.5 dBm may be 0.403 W/Kg. Meanwhile, for the frequency band of B5, the maximum transmission power limit of 23 dBm may be set, and in this case, the maximum SAR value may be 1 mW/g, and the sum of the maximum SAR values of both RATs may be 1.403 W/Kg.

Although FIG. 9C and the accompanying text refer to operations 933 and 935 in sequence, it is to be understood that this sequence is not necessary and that other embodiments exist. For example, the identifying of the second maximum SAR value corresponding to the second maximum transmission power limit set for the second RF path of operation 935 can precede the identifying of the first maximum SAR value corresponding to the first maximum transmission power limit set for the first RF path of operation 933 or, alternatively, the identifying of the first and second maximum SAR values corresponding to the first and second maximum transmission power limits set for the first and second RF paths can be done in parallel with one another or can be simultaneous or at least partially simultaneous.

According to various embodiments, in operation 937, the electronic device 101 may identify whether the predicted accumulated SAR, based on the sum of the first SAR maximum value and the second SAR maximum value, exceeds the SAR margin set to change the RF path. For example, the electronic device 101 may identify whether the product of 1.403 mW/g and the remaining time exceeds the SAR margin set for RF path change. When the accumulated SAR predicted based on the sum of the first SAR maximum value and the second SAR maximum value exceeds the SAR margin set for RF path change (Yes in operation 937), the electronic device 101 may change at least one RF path in operation 939. When the accumulated SAR predicted based on the sum of the first SAR maximum value and the second SAR maximum value is less than or equal to the SAR margin set for RF path change (No in operation 937), the electronic device 101 may maintain the use of the existing RF path in operation 941.

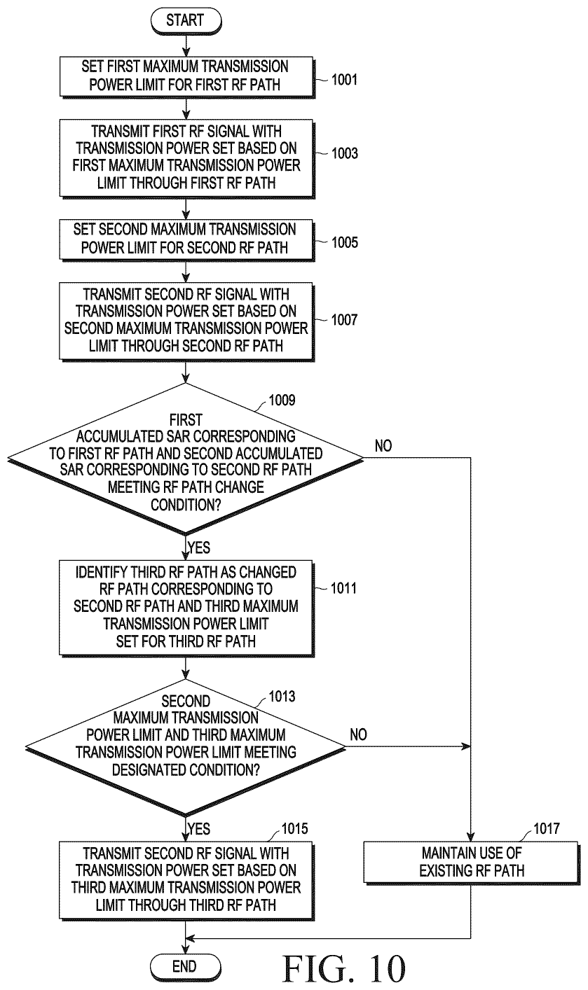

FIG. 10 is a flowchart illustrating a method for operating an electronic device according to various embodiments.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 1001. In operation 1003, the electronic device 101 may transmit the first RF signal with transmission power set based on the first maximum transmission power limit through the first RF path. In operation 1005, the electronic device 101 may set a second maximum transmission power limit for the second RF path. In operation 1007, the electronic device 101 may transmit the second RF signal with transmission power set based on the second maximum transmission power limit through the second RF path. In operation 1009, the electronic device 101 may identify whether the first accumulated SAR corresponding to the first RF path and the second accumulated SAR corresponding to the second RF path meet the RF path change condition. Since the setting of the maximum transmission power and/or the RF path change condition have been described above, the detailed description thereof is not repeated. When the RF path change condition is met (Yes in 1009), the electronic device 101 may identify the third RF path as the changed RF path corresponding to the second RF path and the third maximum transmission power limit set for the third RF path in operation 1011.

Although FIG. 10 and the accompanying text refer to operations 1001-1007 in sequence, it is to be understood that this sequence is not necessary and that other embodiments exist. For example, the setting of the first maximum transmission power limit for the first RF path of operation 1001 and the setting of the second maximum transmission power limit for the second RF path of operation 1005 can be executed in parallel with one another or at least partially simultaneously. Similarly, the transmission of the first RF signal with the first maximum transmission power limit through the first RF path of operation 1003 and the transmission of the second RF signal with the second maximum transmission power limit through the second RF path of operation 1007 can be executed in parallel with one another or at least partially simultaneously.

According to various embodiments, in operation 1013, the electronic device 101 may identify whether the second maximum transmission power limit and the third maximum transmission power limit meet a designated condition. If the second maximum transmission power limit and the third maximum transmission power limit meet the designated condition (Yes in operation 1013), the electronic device 101 may transmit the second RF signal with transmission power set based on the third maximum transmission power limit through the third RF path in operation 1015. If the second maximum transmission power limit and the third maximum transmission power limit do not meet the designated condition (No in operation 1013), or if the RF path change condition is not met (No in operation 1009), the electronic device 101 may maintain the use of the existing RF path in operation 1017. For example, the electronic device 101 may determine whether the third maximum transmission power limit after the change is larger than a designated difference (e.g., 2 dB) than the second maximum transmission power limit before the change, as whether the designated condition is met in operation 1013. In this case, if the third maximum transmission power limit after the change is not larger than the designated difference (e.g., 2 dB) than the second maximum transmission power limit before the change, the electronic device 101 may maintain the use of the existing RF path. Based on the SAR limitation and/or the MPR set for the second RF path and/or the third RF path, the third maximum transmission power limit may not be larger than the second maximum transmission power limit by a designated difference or may be smaller in some cases, and in this case, the change of the RF path may not greatly help communication stability or may be rather disadvantageous. Meanwhile, the value of the designated difference is exemplary, and in various embodiments, the designated difference may be set to differ for each path to be changed, or the designated difference may be set to 0. For example, the designated difference set when the first RF path is changed to the second RF path may be different from the designated difference set when the first RF path is changed to the third RF path. Alternatively, e.g., the designated difference set when the first RF path is changed to the second RF path may be different from the designated difference set when the second RF path is changed to the first RF path.

For example, for the RF path before the change, the maximum transmission power limit based on the average SAR limit may be 22.5 dBm, the maximum transmission power limit due to the backoff due to the SAR limit may be 19.5 dBm (e.g., based on the backoff of 3 dB), and the maximum transmission power limit due to the MPR limit may be 20.5 dBm. The MTPL of the RF path before the change may be 19.5 dBm, which is the minimum value of the above-described values. Further, the maximum transmission power limit for the RF path after the change is 22 dBm based on the RF path loss, and may be 18.5 dBm based on the MPR backoff (e.g., 3.5 dB). As described above, 18.5 dBm, which is the MTPL after the change, may be lower than 19.5 dBm, which is the MTPL before the change, and in this case, it may be more advantageous for communication stability not to perform the RF path change.

According to various embodiments, the electronic device 101 may identify the maximum transmission power limit corresponding to the specific RF of the TDD based on the duty rate. For example, when the duty rate is 25%, the maximum transmission power limit in which +6 dB is applied to the maximum transmission power limit may be determined.

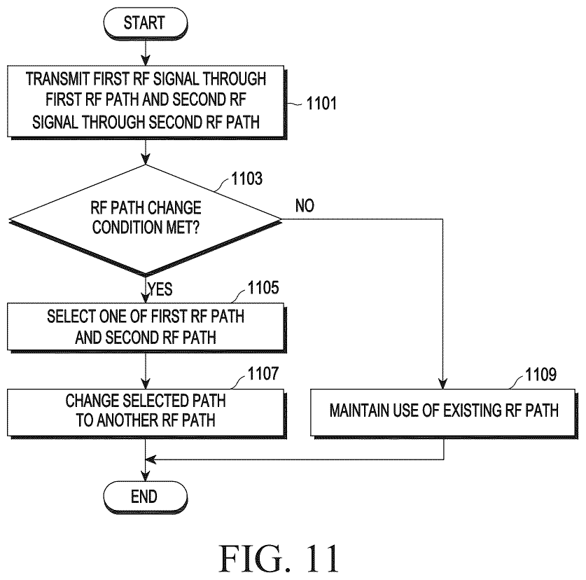

FIG. 11 is a flowchart illustrating a method for operating an electronic device according to various embodiments.

According to an embodiment, the electronic device 101 (e.g., at least one of the processor 120, the first communication processor 212, the second communication processor 214, the integrated communication processor 260, or the communication processor 501) may transmit a first RF signal through the first RF path and a second RF signal through the second RF path in operation 1101. In operation 1103, the electronic device 101 may identify whether the RF path change condition is met. If the RF path change condition is not met (No in operation 1103), the electronic device 101 may maintain the use of the existing RF path in operation 1109. When the RF path change condition is met (Yes in operation 1103), in operation 1105, the electronic device 101 may select one of the first RF path and the second RF path as an RF path to be changed. In operation 1107, the electronic device 101 may change the selected path to another RF path.

For example, when only one of the first RF path and the second RF path is changeable, e.g., when the other RF path is not changeable, the electronic device 101 may select the changeable RF path. For example, the electronic device 101 may compare the priority of the first RF path and the priority of the second RF path, and may select an RF path having a lower priority as a result of the comparison. For example, in MR DC, a relatively high priority may be assigned to the MCG and a relatively low priority may be assigned to the SCG, but this is exemplary and the priorities may be reversely assigned. For example, in DSDA, the electronic device 101 may assign a higher priority to an RF path on which a VoIP service such as VOLTE or VoNR is performed, but this is illustrative. For example, in DSDA, the electronic device 101 may assign a lower priority to an RF path for which an RRC connection is established relatively late, but this is merely an example. For example, the electronic device 101 may be configured not to change the RF path for the RF path corresponding to mmWave. In another example, the electronic device 101 may be configured to change an RF path for an RF path corresponding to mmWave. Changing the RF path corresponding to mmWave is described below.

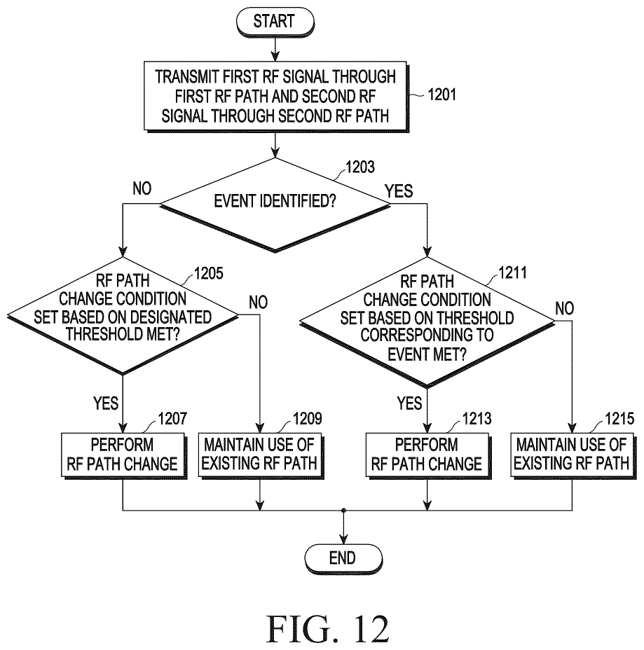

FIG. 12 is a flowchart illustrating a method for operating an electronic device according to an embodiment.

According to an embodiment, the electronic device 101 (e.g., at least one of the processor 120, the first communication processor 212, the second communication processor 214, the integrated communication processor 260, or the communication processor 501) may transmit a first RF signal through the first RF path and a second RF signal through the second RF path in operation 1201. In operation 1203, the electronic device 101 may identify whether a designated event is identified. For example, when the designated event is not identified (No in operation 1203), the electronic device 101 may identify whether the RF path change condition set based on the designated threshold is met in operation 1205. Here, the designated threshold may be, e.g., a default value. When the RF path change condition is met (Yes in 1205), the electronic device 101 may perform at least one RF path change in operation 1207. When the RF path change condition is not met (No in operation 1205), the electronic device 101 may maintain the use of the existing RF path in operation 1209. For example, when the value obtained by dividing the remaining SAR margin by the accumulated SAR limit is less than the default value, the electronic device 101 may determine to change at least one RF path. For example, when the value obtained by dividing the value obtained by dividing remaining SAR margin by the accumulated SAR limit, by the remaining time is less than the default value, the electronic device 101 may determine to change at least one RF path. For example, the electronic device 101 may determine to change at least one RF path when the value obtained by the value obtained by dividing the remaining SAR margin by the SAR maximum consumption of the unchanged RF path, by the remaining time is less than the default value (e.g., 0.8). For example, when the remaining SAR margin is 50 mW/g, the maximum SAR consumption of the unchanged RF path is 1 mW/g, and the remaining time is 40 seconds, the corresponding value may be 1.25 seconds. This may mean that the maximum transmission power limit may be maintained in the RF path that does not change for 50 seconds, which is larger than the remaining time of 40 seconds.

According to various embodiments, when the designated event is identified (Yes in operation 1203), the electronic device 101 may identify whether the RF path change condition set based on the threshold corresponding to the event is met in operation 1211. For example, the electronic device 101 may select a threshold for setting the RF path change condition in response to the identified event. The electronic device 101 may set a threshold for each event (e.g., a grip event, an ear-jack plug-in event, a USB plug-in event, or a VoIP), and when a specific event is identified, the electronic device 101 may use the threshold corresponding to the event to determine whether to change the RF path. For example, when the default value corresponding to the value obtained by the value obtained by dividing the remaining SAR margin by the maximum SAR consumption of the unchanged RF path by the remaining time is 0.8, the threshold when the VOIP is in use may be set to differ as 1. When the RF path change condition is met (Yes in 1211), the electronic device 101 may perform at least one RF path change in operation 1213. When the RF path change condition is not met (No in operation 1211), the electronic device 101 may maintain the use of the existing RF path in operation 1215.

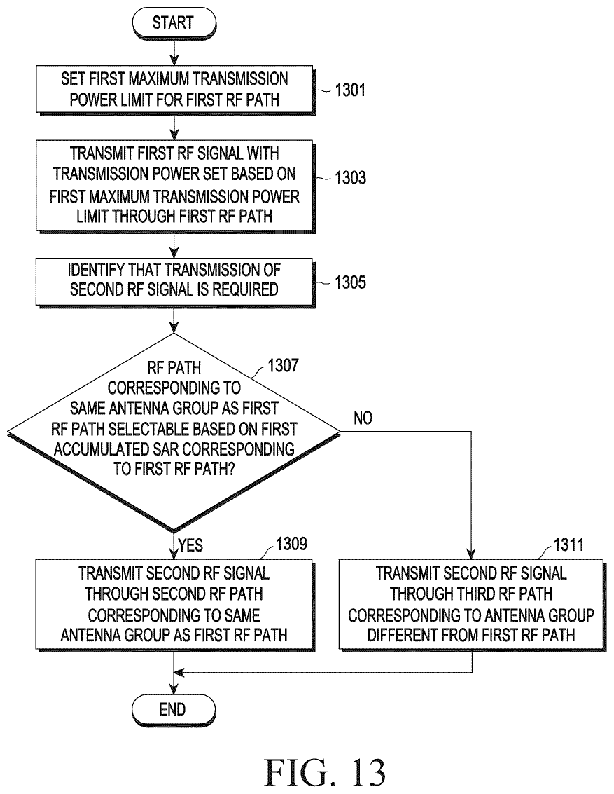

FIG. 13 is a flowchart illustrating a method for operating an electronic device according to various embodiments.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 1301. In operation 1303, the electronic device 101 may transmit the first RF signal with transmission power set based on the first maximum transmission power limit through the first RF path. In operation 1305, the electronic device 101 may identify that transmission of the second RF signal is required. For example, the electronic device 101 may identify that transmission of the second RF signal is required based on SCG addition. Alternatively, the electronic device 101 may identify that transmission of the second RF signal is required based on RRC connection (or RA execution) of another SIM according to the DSDA being required. Meanwhile, the above-described example in which transmission of the second RF signal is required is merely exemplary, and the type thereof is not limited.

According to various embodiments, in operation 1307, the electronic device 101 may identify whether an RF path corresponding to the same antenna group as the first RF path is selectable, based on the first accumulated SAR corresponding to the first RF path. As described above, when the antennas of the plurality of RF paths are included in the same antenna group, the electronic device 101 should determine whether to back off the MTPL based on the sum of the SARs corresponding to the plurality of RF paths, and there is a possibility that early backoff may be performed. Accordingly, in operation 1307, the electronic device 101 may determine whether to transmit the second RF signal using the second RF path corresponding to the same antenna group or using the third RF path corresponding to different antenna groups, using the first accumulated SAR corresponding to the first RF path. In one example, the electronic device 101 may determine whether to transmit the second RF signal using the second RF path corresponding to the same antenna group or using the third RF path corresponding to different antenna groups, using the first accumulated SAR corresponding to the first RF path, based on whether the sum of the first accumulated SAR and the SARs predicted in the future in the first RF path and the second RF path exceeds a threshold set to be smaller than the Max accumulated SAR. If it is identified that the RF path corresponding to the same antenna group as the first RF path is selectable (Yes in operation 1307), the electronic device 101 may transmit the second RF signal through the second RF path corresponding to the same antenna group as the first RF path in operation 1309. If it is identified that the RF path corresponding to the same antenna group as the first RF path is not selectable (No in 1307), the electronic device 101 may transmit the second RF signal through the third RF path corresponding to the antenna group different from the first RF path in operation 1311. Accordingly, the backoff of the MTPL for any one of both RF signals may be delayed or prevented according to the transmission of the second RF signal.

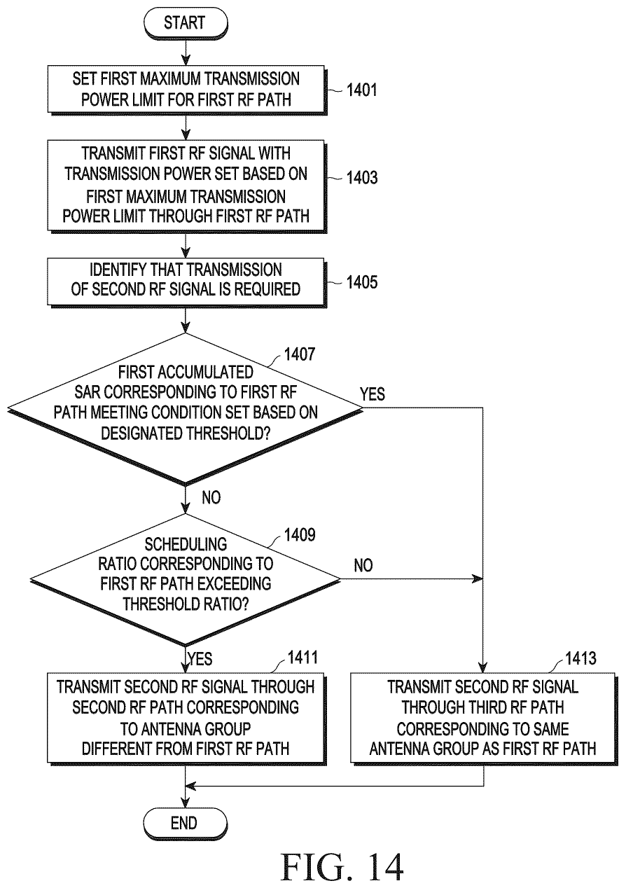

FIG. 14 is a flowchart illustrating a method for operating an electronic device according to an embodiment.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 1401. In operation 1403, the electronic device 101 may transmit the first RF signal with transmission power set based on the first maximum transmission power limit through the first RF path. In operation 1405, the electronic device 101 may identify that transmission of the second RF signal is required. In operation 1407, the electronic device 101 may identify whether the first accumulated SAR corresponding to the first RF path meets a set condition based on a designated threshold. The condition here may be, e.g., a condition for determining whether to use the same antenna group or different antenna groups as/from the first RF path for the second RF path. For example, when the condition is met, the antennas may be allocated to the same antenna group without further consideration. If it is identified that the condition is met (Yes in 1407), the electronic device 101 may transmit the second RF signal through the third RF path corresponding to the same antenna group as the first RF path in operation 1413.

According to various embodiments, when it is identified that the condition is not met (No in 1407), the electronic device 101 may identify whether the scheduling ratio corresponding to the first RF path is equal to or larger than a threshold ratio (e.g., 70% but not limited thereto) in operation 1409. If the scheduling ratio corresponding to the first RF path exceeds the threshold ratio (Yes in 1409), the electronic device 101 may transmit the second RF signal through the second RF path corresponding to the antenna group different from the first RF path in operation 1411. If the scheduling ratio corresponding to the first RF path is less than or equal to the threshold ratio (No in 1409), the electronic device 101 may transmit the second RF signal through the third RF path corresponding to the same antenna group as the first RF path in operation 1413. In one example, the first RF signal may be a Sub6 signal, and the second RF signal may be an mmWave signal. When the scheduling ratio is set to be relatively large, there is a possibility that the transmission power of the Sub6 signal may be set to be relatively large. In this case, there is a possibility that the transmission power of the mmWave signal may be set to be relatively low. If the size (e.g., 10 seconds) of the time window set for Sub6 is different (e.g., larger) from the size (e.g., 4 seconds) of the time window set for mmWave, the SAR margin of the mmWave signal is set to be relatively low, and thus the transmission power of the mmWave signal may be set to be excessively low. Accordingly, when the scheduling ratio of the first RF signal exceeds the threshold ratio, the RF path of the second RF signal may be set to an antenna group different from the RF path of the first RF signal considering the possibility that the transmission power of the second RF signal is set to be relatively low.

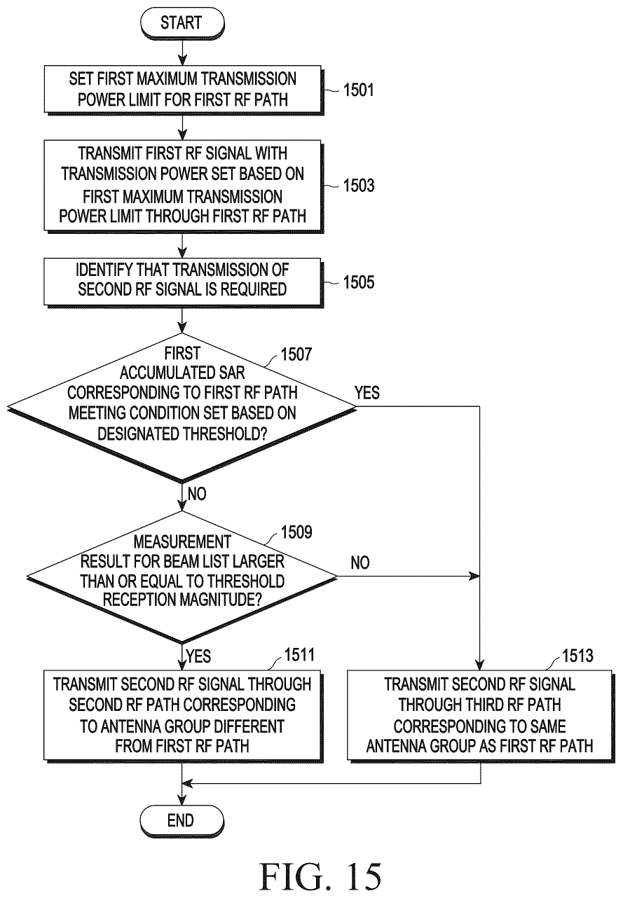

FIG. 15 is a flowchart illustrating a method for operating an electronic device according to an embodiment.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 1501. In operation 1503, the electronic device 101 may transmit the first RF signal with transmission power set based on the first maximum transmission power limit through the first RF path. In operation 1505, the electronic device 101 may identify that transmission of the second RF signal is required. In one example, the second RF signal may be, e.g., an mmWave signal. In operation 1507, the electronic device 101 may identify whether the first accumulated SAR corresponding to the first RF path meets a set condition based on a designated threshold. The condition here may be, e.g., a condition for determining whether to use the same antenna group or different antenna groups as/from the first RF path for the second RF path. If it is identified that the condition is met (Yes in 1507), the electronic device 101 may transmit the second RF signal through the third RF path corresponding to the same antenna group as the first RF path in operation 1513.

According to various embodiments, if it is identified that the condition is not met (No in 1507), the electronic device 101 may identify whether the measurement result for the beam list for the second RF signal is larger than or equal to the threshold reception magnitude in operation 1509. When the measurement result is larger than or equal to the threshold reception magnitude (Yes in 1509), the electronic device 101 may transmit the second RF signal through the second RF path corresponding to the antenna group different from the first RF path in operation 1511. For example, the electronic device 101 may measure the reception strength of the SSB and/or CSI-RS in the mmWave module for the second RF signal. For example, the electronic device 101 may manage the beam list of the measurement target corresponding to the beam index used by the mmWave module for the first RF signal, and may measure the reception strength of the beam list. For example, N (e.g., 5) beam lists may correspond to a specific beam for the first RF signal. The electronic device 101 may measure the reception strength of the N beam lists. It will be understood by one of ordinary skill in the art that the above-described beam list is merely exemplary, and the beam index measured by the mmWave module for the second RF signal is not limited. Alternatively, when the ratio of the reception strength of the mmWave module for the second RF signal to the reception strength of the mmWave module for the first RF signal is larger than or equal to the threshold ratio (in other words, when the degradation of the second RF signal is less than or equal to a threshold level), the electronic device 101 may transmit the second RF signal through the second RF path corresponding to the antenna group different from the first RF path. If the measurement result is less than the threshold reception magnitude (No in 1509), the electronic device 101 may transmit the second RF signal through the third RF path corresponding to the same antenna group as the first RF path in operation 1513. When the measurement result is less than the threshold reception magnitude, the electronic device 101 may transmit the second RF signal through the third RF path corresponding to the same antenna group, and may back off the MTPL if SAR limit is predicted. Meanwhile, in another embodiment, the electronic device 101 may transmit the second RF signal through the second RF path corresponding to the antenna group different from the first RF path, and may receive the RF signal of the RAT (or SIM) corresponding to the second RF signal using the mm Wave module for the first RF signal.

In one example, the electronic device 101 may include a plurality of mmWave modules. The electronic device 101 may identify that transmission of the second RF signal is required while transmitting the existing first RF signal. In one example, the electronic device 101 may be configured not to perform beam searching with an mmWave module belonging to the same antenna group as the antenna of the first RF signal, but to perform beam searching with an mmWave module belonging to an antenna group different from the antenna of the first RF signal. In another example, when the SAR margin corresponding to the first RF signal is less than or equal to the threshold margin, the electronic device 101 may be configured not to perform beam searching with an mmWave module belonging to the same antenna group as the antenna of the first RF signal, but to perform beam searching with an mmWave module belonging to an antenna group different from the antenna of the first RF signal. In another example, when the value obtained by dividing the transmission power corresponding to the first RF signal by the average SAR power limit is equal to or larger than the threshold ratio, the electronic device 101 may be configured not to perform beam searching with an mmWave module belonging to the same antenna group as the antenna of the first RF signal, but to perform beam searching with an mmWave module belonging to an antenna group different from the antenna of the first RF signal.

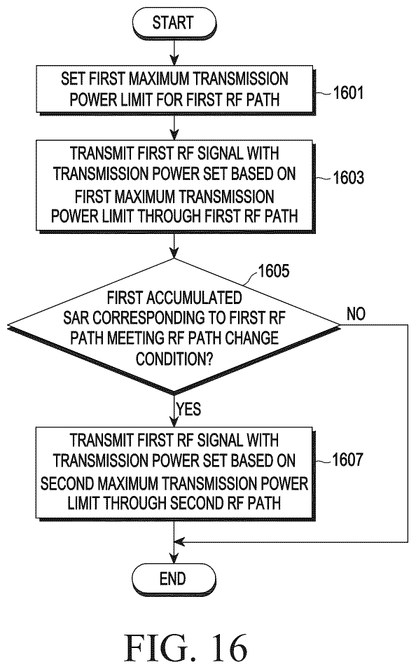

FIG. 16 is a flowchart illustrating a method for operating an electronic device according to various embodiments.

According to an embodiment, the electronic device 101 (e.g., at least one of the processor 120, the first communication processor 212, the second communication processor 214, the integrated communication processor 260, or the communication processor 501) may set a first maximum transmission power limit for the first RF path in operation 1601. In operation 1603, the electronic device 101 may transmit the first RF signal with transmission power set based on the first maximum transmission power limit through the first RF path. In operation 1605, the electronic device 101 may identify whether the first accumulated SAR corresponding to the first RF path meets the RF path change condition. For example, the RF path change condition may be that the sum of the first accumulated SAR and the predicted SAR at the current time and/or the future time corresponding to the first RF path exceeds a threshold set to be smaller than the Max accumulated SAR set for backoff, but is not limited thereto. Based on the RF path change condition being met (Yes in 1605), the electronic device 101 may transmit the first RF signal with the transmission power set based on the second maximum transmission power limit through the second RF path in operation 1607. The antenna of the second RF path may be included in an antenna group different from the antenna of the first RF path. The second maximum transmission power limit may be the same as the first maximum transmission power limit, but may be set to differ in some cases. As described above, the electronic device 101 may transmit the first RF signal without backoff of the MTPL (or while delaying the backoff time of the MTPL).

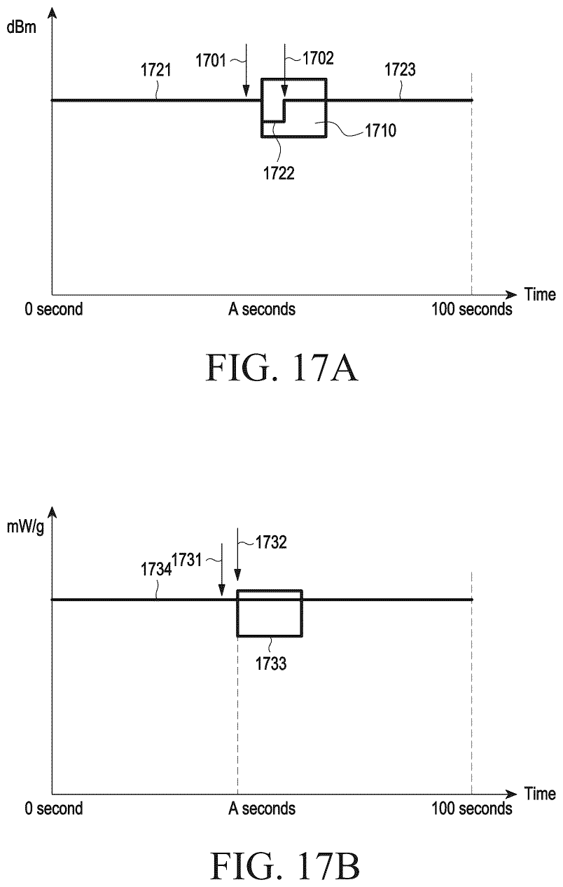

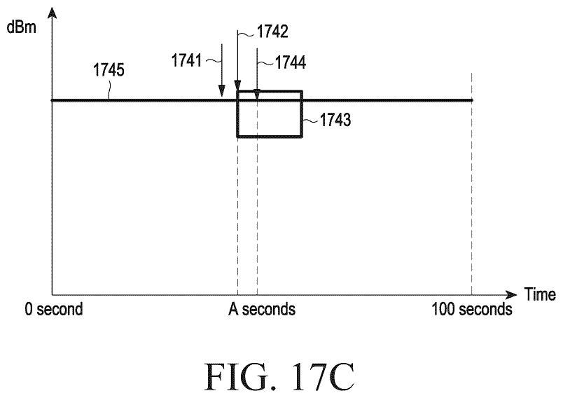

FIG. 17A is a view illustrating a time for determining whether an RF path is changed and/or an RF path change time according to a comparison example and various embodiments. FIGS. 17B and 17C are views illustrating a time for determining whether an RF path is changed and/or an RF path change time according to various embodiments. At least some of the operations performed by the electronic device according to the comparative example may also be performed by an electronic device according to various embodiments.

Referring to FIG. 17A, the electronic device 101 (e.g., at least one of the processor 120, the first communication processor 212, the second communication processor 214, the integrated communication processor 260, or the communication processor 501) may determine whether to change the RF path every first period. In FIG. 17A, the electronic device 101 may determine whether to change the RF path based on the time window at a first time 1701. For example, at the first time 1701, the electronic device 101 may determine that an RF path change is not required. Meanwhile, at a second time 1702 after a first period has elapses, the electronic device 101 may determine whether to change the RF path. For example, at the second time 1702, the electronic device 101 may determine that an RF path change is required. Meanwhile, the electronic device 101 may identify that the backoff of the MTPL is required based on the time window 1710 at a time between the first time 1701 and the second time 1702. Accordingly, the electronic device 101 may back off the MTPL set to the first value 1721, to the second value 1722. Thereafter, the electronic device 101 may change the RF path at the second time 1702, and may set the MTPLE back to the first value 1721 (or another value). As described above, according to the comparative example, there is a possibility that the backoff of the MTPL is performed before the RF path is changed.

Referring to FIG. 17B, according to various embodiments, the electronic device 101 may determine whether to change the RF path at the first time 1731. For example, as illustrated in FIG. 17A, a threshold for RF path change may be set so that the backoff of the MTPL does not occur according to the period (e.g., the first period) for determining whether to change the RF path. Accordingly, the electronic device 101 may complete the RF change 1732 at the second time 1732 when the time required by performing the operation for RF change has elapsed from the first time 1731. At the second time 1732, the electronic device 101 may determine whether backoff of the MTPL is required, e.g., based on the time window 1733, and may determine that backoff of the MTPL is not required because the RF change has already been performed. As described above, the electronic device 101 may set a threshold for determining whether to change the RF path so that the backoff of the MTPL is not performed considering the period for determining whether to change the RF path. Accordingly, the MTPL may be maintained without being backed off to the first value 1734. Alternatively, referring to FIG. 17C, according to various embodiments, the electronic device 101 may determine whether to change the RF path at the first time 1741. The electronic device 101 may determine that the RF path change is not required at the first time 1741. The electronic device 101 may identify that the backoff of the MTPL is required based on the time window 1743 at the second time 1742. In this case, the electronic device 101 may be configured to immediately change the RF path at a third time 1744, without performing the backoff of the MTPL while identifying that the backoff of the MTPL is required. Accordingly, the MTPL may be maintained without being backed off to the first value 1734.

According to various embodiments, an electronic device (e.g., the electronic device 101) may comprise a plurality of antennas (e.g., at least one of the first antenna module 242, the second antenna module 244, the third antenna module 246, the antennas 248, or the antennas 521, 522, 523, and 524), at least one RF circuit (e.g., at least one of the first RFIC 222, the second RFIC 224, the third RFIC 226, the fourth RFIC 228, the first RFFE 232, the second RFFE 234, the third RFFE 236, the RFIC 503, the first RFFE 505, or the second RFFE 507), memory storing instructions, and at least one processor (e.g., at least one of the processor 120, the first communication processor 212, the second communication processor 214, the integrated communication processor 260, or the communication processor 501). The instructions may cause the electronic device to set a first maximum transmission power limit for a first RF path of the electronic device, the first RF path being associated with a first antenna among the plurality of antennas, control at least part of the at least one RF circuit associated with the first RF path to transmit a first RF signal with a transmission power set based on the first maximum transmission power limit, through the first RF path, set a second maximum transmission power limit for a second RF path of the electronic device, the second RF path being associated with a second antenna among the plurality of antennas, and a distance between the first antenna and the second antenna being less than a designated threshold distance, control at least part of the at least one RF circuit associated with the second RF path to transmit a second RF signal with a transmission power set based on the second maximum transmission power limit, through the second RF path, identify whether a first accumulated SAR corresponding to the first RF path and a second accumulated SAR corresponding to the second RF path satisfy an RF path change condition, based on the first accumulated SAR and the second accumulated SAR satisfying the RF path change condition, control at least part of the at least one RF circuit associated with a third RF path to transmit the second RF signal with a transmission power set based on a third maximum transmission power limit, through the third RF path of the electronic device, the third RF path being associated with a third antenna among the plurality of antennas, and a distance between the first antenna and the third antenna being larger than or equal to a designated threshold distance, and control at least part of the at least one RF circuit associated with the first RF path to transmit the first RF signal with the transmission power set based on the first maximum transmission power limit, through the first RF path.

According to various embodiments, the third maximum transmission power limit may be substantially the same as the first maximum transmission power limit.

According to various embodiments, the third maximum transmission power limit may be different from the first maximum transmission power limit. The at least one processor may be further configured to determine to transmit the second RF signal through the third RF path, based on the third maximum transmission power limit being larger than the first maximum transmission power limit by a designated difference or more.

According to various embodiments, the instructions may cause the electronic device to, as at least part of identifying whether the first accumulated SAR and the second accumulated SAR satisfy the RF path change condition, identify a first SAR maximum value corresponding to the first maximum transmission power limit and a second SAR maximum value corresponding to the second maximum transmission power limit, and identify whether an accumulated SAR predicted by the first SAR maximum value and the second SAR maximum value at remaining times in a timetable exceeds an SAR margin set for RF path change. The SAR margin may be set based on the first accumulated SAR and the second accumulated SAR.

According to various embodiments, the instructions may cause the electronic device to, as at least part of identifying the first SAR maximum value corresponding to the first maximum transmission power limit and the second SAR maximum value corresponding to the second maximum transmission power limit, identify the first maximum transmission power limit and the second maximum transmission power limit based on a maximum transmission power limit allocated when simultaneously transmitting the first RF signal and the second RF signal.

According to various embodiments, the instructions may cause the electronic device to, as at least part of identifying the first SAR maximum value corresponding to the first maximum transmission power limit and the second SAR maximum value corresponding to the second maximum transmission power limit, identify the first maximum transmission power limit and the second maximum transmission power limit, based on at least one parameter for maximum power reduction (MPR) when transmitting the first RF signal and/or the second RF signal.

According to various embodiments, the at least one processor may be further configured to select the second RF path from of the first RF path and the second RF path, based on the first accumulated SAR and the second accumulated SAR satisfying the RF path change condition.

According to various embodiments, the first RF signal and the second RF signal may be signals for dual connectivity. The instructions may cause the electronic device to, as at least part of selecting the second RF path of the first RF path and the second RF path, select the second RF path, based on a type of a cell group corresponding to each of the first RF path and the second RF path.

According to various embodiments, the first RF signal and the second RF signal may be RF signals based on a DSDA mode of a dual SIM. The instructions may cause the electronic device to, as at least part of selecting the second RF path of the first RF path and the second RF path, select the second RF path, based on an RRC connection time in a SIM corresponding to the first RF path and an RRC connection time in a SIM corresponding to the second RF path.

According to various embodiments, the instructions may cause the electronic device to, as at least part of selecting the second RF path of the first RF path and the second RF path, select the second RF path, based on an RF path where VOIP is being performed, of the first RF path or the second RF path.

According to various embodiments, the instructions may cause the electronic device to, as at least part of identifying whether the first accumulated SAR and the second accumulated SAR satisfy the RF path change condition, based on an occurrence of an event being identified, identify whether the RF path change condition corresponding to the identified event is met, and identify whether a default RF path change condition is met, based on the occurrence of the event not being identified.

According to various embodiments, the instructions may cause the electronic device to, as at least part of identifying whether the first accumulated SAR and the second accumulated SAR satisfy the RF path change condition, identify to change the second RF path to the third RF path, based on the first accumulated SAR and the second accumulated SAR satisfying the RF path change condition and a scheduling ratio corresponding to the first RF path exceeding a threshold ratio.

According to various embodiments, the instructions may cause the electronic device to, as at least part of identifying whether the first accumulated SAR and the second accumulated SAR satisfy the RF path change condition, identify to change the second RF path to the third RF path, based on the first accumulated SAR and the second accumulated SAR satisfying the RF path change condition and a reception strength measured from at least part, corresponding to the second RF signal, of the at least one RF circuit being equal to or larger than a threshold reception strength.

According to various embodiments, a method for operating an electronic device (e.g., the electronic device 101) including a plurality of antennas (e.g., at least one of the first antenna module 242, the second antenna module 244, the third antenna module 246, the antennas 248, or the antennas 521, 522, 523, and 524) and at least one RF circuit (e.g., at least one of the first RFIC 222, the second RFIC 224, the third RFIC 226, the fourth RFIC 228, the first RFFE 232, the second RFFE 234, the third RFFE 236, the RFIC 503, the first RFFE 505, or the second RFFE 507) may comprise setting a first maximum transmission power limit for a first RF path of the electronic device, the first RF path being associated with a first antenna among the plurality of antennas, controlling at least part of the at least one RF circuit associated with the first RF path to transmit a first RF signal with a transmission power set based on the first maximum transmission power limit, through the first RF path, setting a second maximum transmission power limit for a second RF path of the electronic device, the second RF path being associated with a second antenna among the plurality of antennas, and a distance between the first antenna and the second antenna being less than a designated threshold distance, controlling at least part of the at least one RF circuit associated with the second RF path to transmit a second RF signal with a transmission power set based on the second maximum transmission power limit, through the second RF path, identifying whether a first accumulated SAR corresponding to the first RF path and a second accumulated SAR corresponding to the second RF path satisfy an RF path change condition, based on the first accumulated SAR and the second accumulated SAR satisfying the RF path change condition, controlling at least part of the at least one RF circuit associated with a third RF path to transmit the second RF signal with a transmission power set based on a third maximum transmission power limit, through the third RF path of the electronic device, the third RF path being associated with a third antenna among the plurality of antennas, and a distance between the first antenna and the third antenna being larger than or equal to a designated threshold distance, and controlling at least part of the at least one RF circuit associated with the first RF path to transmit the first RF signal with the transmission power set based on the first maximum transmission power limit, through the first RF path.

According to various embodiments, the third maximum transmission power limit may be substantially the same as the first maximum transmission power limit.

According to various embodiments, the third maximum transmission power limit may be different from the first maximum transmission power limit. The method for operating the electronic device may further comprise determining to transmit the second RF signal through the third RF path, based on the third maximum transmission power limit being larger than the first maximum transmission power limit by a designated difference or more.

According to various embodiments, the method for operating the electronic device may further comprise selecting the second RF path from of the first RF path and the second RF path, based on the first accumulated SAR and the second accumulated SAR satisfying the RF path change condition.

According to various embodiments, identifying whether the first accumulated SAR and the second accumulated SAR satisfy the RF path change condition may identify to change the second RF path to the third RF path, based on the first accumulated SAR and the second accumulated SAR satisfying the RF path change condition and a scheduling ratio corresponding to the first RF path exceeding a threshold ratio.

According to various embodiments, identifying whether the first accumulated SAR and the second accumulated SAR satisfy the RF path change condition may identify to change the second RF path to the third RF path, based on the first accumulated SAR and the second accumulated SAR satisfying the RF path change condition and a reception strength measured from at least part, corresponding to the second RF signal, of the at least one RF circuit being equal to or larger than a threshold reception strength.

According to various embodiments, an electronic device (e.g., the electronic device 101) may comprise a plurality of antennas (e.g., at least one of the first antenna module 242, the second antenna module 244, the third antenna module 246, the antennas 248, or the antennas 521, 522, 523, and 524), at least one RF circuit (e.g., at least one of the first RFIC 222, the second RFIC 224, the third RFIC 226, the fourth RFIC 228, the first RFFE 232, the second RFFE 234, the third RFFE 236, the RFIC 503, the first RFFE 505, or the second RFFE 507), memory storing instructions, and at least one processor (e.g., at least one of the processor 120, the first communication processor 212, the second communication processor 214, the integrated communication processor 260, or the communication processor 501). The instructions may cause the electronic device to set a first maximum transmission power limit for a first RF path of the electronic device, the first RF path being associated with a first antenna among the plurality of antennas, control at least part of the at least one RF circuit associated with the first RF path to transmit a first RF signal with a transmission power set based on the first maximum transmission power limit, through the first RF path, identify whether a first accumulated SAR corresponding to the first RF path satisfies a designated condition based on identifying that transmission of a second RF signal different from the first RF signal is required, set a second maximum transmission power limit for a second RF path of the electronic device based on the first accumulated SAR satisfying the designated condition, control at least part of the at least one RF circuit associated with the second RF path to transmit the second RF signal with a transmission power set based on the second maximum transmission power limit, the second RF path being associated with a second antenna among the plurality of antennas, and a distance between the first antenna and the second antenna being less than a designated threshold distance, set a third maximum transmission power limit for a third RF path of the electronic device based on the first accumulated SAR not satisfying the designated condition, control at least part of the at least one RF circuit associated with the third RF path to transmit the second RF signal with a transmission power set based on the third maximum transmission power limit, the third RF path being associated with a third antenna among the plurality of antennas, and a distance between the first antenna and the third antenna being the designated threshold distance or more.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a plurality of antennas;
an RF circuit;
memory storing instructions; and
at least one processor;
wherein the instructions that, when executed by the at least one processor individually or collectively, cause the electronic device to:
set a first maximum transmission power limit for a first radio frequency (RF) path, which is associated with a first antenna among the plurality of antennas;
control a first part of the RF circuit associated with the first RF path to transmit a first RF signal with a transmission power set based on the first maximum transmission power limit through the first RF path;
set a second maximum transmission power limit for a second RF path, which is associated with a second antenna among the plurality of antennas, a distance between the first antenna and the second antenna being less than a first threshold distance;
control a second part of the RF circuit associated with the second RF path to transmit a second RF signal with a transmission power set based on the second maximum transmission power limit through the second RF path;
identify whether a first accumulated specific absorption rate (SAR) corresponding to the first RF path and a second accumulated SAR corresponding to the second RF path satisfy an RF path change condition; and
based on the first accumulated SAR and the second accumulated SAR satisfying the RF path change condition:
control a third part of the RF circuit associated with a third RF path to transmit the second RF signal with a transmission power set based on a third maximum transmission power limit through the third RF path of the electronic device, the third RF path being associated with a third antenna among the plurality of antennas and a distance between the first antenna and the third antenna being larger than or equal to a second threshold distance; and
control the first part of the RF circuit associated with the first RF path to transmit the first RF signal with the transmission power set based on the first maximum transmission power limit through the first RF path.

2. The electronic device of claim 1, wherein the third maximum transmission power limit is substantially equal to the first maximum transmission power limit.

3. The electronic device of claim 1, wherein the third maximum transmission power limit differs from the first maximum transmission power limit, and
wherein the instructions cause the electronic device to determine to transmit the second RF signal through the third RF path based on the third maximum transmission power limit being larger than the first maximum transmission power limit by a designated difference or more.

4. The electronic device of claim 1, wherein the instructions cause the electronic device to, as at least part of identifying whether the first accumulated SAR and the second accumulated SAR satisfy the RF path change condition:
identify a first SAR maximum value corresponding to the first maximum transmission power limit and a second SAR maximum value corresponding to the second maximum transmission power limit; and
identify whether an accumulated SAR predicted by the first SAR maximum value and the second SAR maximum value at remaining times in a timetable exceeds an SAR margin set for RF path change, wherein the SAR margin is set based on the first accumulated SAR and the second accumulated SAR.

5. The electronic device of claim 4, wherein the instructions cause the electronic device to, as at least part of identifying the first SAR maximum value corresponding to the first maximum transmission power limit and the second SAR maximum value corresponding to the second maximum transmission power limit,
identify the first maximum transmission power limit and the second maximum transmission power limit based on a maximum transmission power limit allocated when simultaneously transmitting the first RF signal and the second RF signal.

6. The electronic device of claim 4, wherein the instructions cause the electronic device to, as at least part of identifying the first SAR maximum value corresponding to the first maximum transmission power limit and the second SAR maximum value corresponding to the second maximum transmission power limit,
identify the first maximum transmission power limit and the second maximum transmission power limit based on at least one parameter for maximum power reduction (MPR) when transmitting the first RF signal and/or the second RF signal.

7. The electronic device of claim 1, wherein the instructions cause the electronic device to select the second RF path from of the first RF path and the second RF path based on the first accumulated SAR and the second accumulated SAR satisfying the RF path change condition.

8. The electronic device of claim 7, wherein the first RF signal and the second RF signal are signals for dual connectivity, and wherein the instructions cause the electronic device to, as at least part of selecting the second RF path of the first RF path and the second RF path, select the second RF path based on a type of a cell group corresponding to each of the first RF path and the second RF path.

9. The electronic device of claim 7, wherein the first RF signal and the second RF signal are RF signals based on a DSDA mode of a dual SIM, and
wherein the instructions cause the electronic device to, as at least part of selecting the second RF path of the first RF path and the second RF path, select the second RF path based on an RRC connection time in a SIM corresponding to the first RF path and an RRC connection time in a SIM corresponding to the second RF path.

10. The electronic device of claim 7, wherein the instructions cause the electronic device to, as at least part of selecting the second RF path of the first RF path and the second RF path, select the second RF path based on an RF path where voice over internet protocol (VOIP) is being performed of the first RF path or the second RF path.

11. The electronic device of claim 1, wherein the instructions cause the electronic device to, as at least part of identifying whether the first accumulated SAR and the second accumulated SAR satisfy the RF path change condition:
based on an occurrence of an event being identified, identify whether the RF path change condition corresponding to the identified event is satisfied; and
identify whether a default RF path change condition is satisfied based on the occurrence of the event not being identified.

12. The electronic device of claim 1, wherein the instructions cause the electronic device to, as at least part of identifying whether the first accumulated SAR and the second accumulated SAR satisfy the RF path change condition, identify to change the second RF path to the third RF path based on the first accumulated SAR and the second accumulated SAR satisfying the RF path change condition and a scheduling ratio corresponding to the first RF path exceeding a threshold ratio.

13. The electronic device of claim 1, wherein the instructions cause the electronic device to, as at least part of identifying whether the first accumulated SAR and the second accumulated SAR satisfy the RF path change condition, identify to change the second RF path to the third RF path based on the first accumulated SAR and the second accumulated SAR satisfying the RF path change condition and a reception strength measured from the second part of the RF circuit being equal to or larger than a threshold reception strength.

14. An operation method of an electronic device including a plurality of antennas and a radio frequency (RF) circuit, the operation method comprising:
setting a first maximum transmission power limit for a first RF path of the electronic device, the first RF path being associated with a first antenna among the plurality of antennas;
controlling a first part of the RF circuit associated with the first RF path to transmit a first RF signal with a transmission power set based on the first maximum transmission power limit through the first RF path;
setting a second maximum transmission power limit for a second RF path of the electronic device, which is associated with a second antenna among the plurality of antennas, and a distance between the first antenna and the second antenna being less than a first threshold distance;
controlling a second part of the RF circuit associated with the second RF path to transmit a second RF signal with a transmission power set based on the second maximum transmission power limit through the second RF path;
identifying whether a first accumulated specific absorption rate (SAR) corresponding to the first RF path and a second accumulated SAR corresponding to the second RF path satisfy an RF path change condition;
based on the first accumulated SAR and the second accumulated SAR satisfying the RF path change condition:
controlling a third part of the RF circuit associated with a third RF path to transmit the second RF signal with a transmission power set based on a third maximum transmission power limit through the third RF path of the electronic device, the third RF path being associated with a third antenna among the plurality of antennas, and a distance between the first antenna and the third antenna being larger than or equal to a second threshold distance; and
controlling the first part of the RF circuit associated with the first RF path to transmit the first RF signal with the transmission power set based on the first maximum transmission power limit through the first RF path.

15. The operation method of claim 14, wherein identifying whether the first accumulated SAR and the second accumulated SAR satisfy the RF path change condition includes identifying to change the second RF path to the third RF path based on the first accumulated SAR and the second accumulated SAR satisfying the RF path change condition and a scheduling ratio corresponding to the first RF path exceeding a threshold ratio.

16. The operation method of claim 14, wherein:
the setting of the first and second maximum transmission power limits for the first and second RF paths, respectively, are executed at least partially simultaneously, and
the controlling of the first and second parts of the RF circuit associated with the first and second RF paths, respectively, are executed at least partially simultaneously.

17. An operation method of an electronic device, the operation method comprising:
transmitting first and second radio frequency (RF) signals through first and second RF paths, respectively;
determining first and second specific absorption rates (SARs) corresponding to the first and second RF paths, respectively;
calculating a sum of the first and second SARs;
comparing the sum with a designated backoff condition to determine whether the sum meets the designated backoff condition; and
backing off a maximum transmission power limit for at least one of the first and second RF paths.

18. The operation method of claim 17, wherein respective antennae for the first and second RF paths are included in a same antenna group of the electronic device, which comprises one or more additional RF paths and one or more additional antennae respectively corresponding to the one or more additional RF paths.

19. The operation method of claim 17, wherein the backing off of the maximum transmission power limit comprises at least one of:
changing the first RF path to another RF path; and
changing the second RF path to another RF path.

20. The operation method of claim 17, wherein the backing off of the maximum transmission power limit comprises:
transmitting the second RF signal with a transmission power set based on a third maximum transmission power limit through a third RF path; and
transmitting the first RF signal with a transmission power set based on a first maximum transmission power limit through the first RF path.
